(19) United States
(12) Patent Application Publication
(10) Pub. No.: US 2026/0074913 A1
(43) Pub. Date: Mar. 12, 2026

(54) DIGITAL SIGNATURE SYSTEM, AND METHOD

(71) Applicant: NEC Corporation, Tokyo (JP)

(72) Inventors: Saki OTSUKI, Tokyo (JP); Hiroto TAMIYA, Tokyo (JP); Toshiyuki ISSHIKI, Tokyo (JP)

(73) Assignee: NEC Corporation, Tokyo (JP)

(21) Appl. No.: 19/314,194

(22) Filed: Aug. 29, 2025

(30) Foreign Application Priority Data
Sep. 9, 2024 (JP) 2024-155250

(51) Int. Cl. H04L 9/32; H04L 9/08

(52) U.S. Cl. CPC H04L 9/3247; H04L 9/0866

(57) ABSTRACT

A first signature generation apparatus generates a second distributed key and by using a second distributed key and third secret information and exchanging information with a second signature generation apparatus, generates a second distributed signature for a message. The second signature generation apparatus acquires second biometric information and restores second secret information using second biometric information and helper data, generates a first distributed key, and by using the first distributed key and the second secret information, and exchanging information with the first signature generation apparatus, generates the first distributed signature for the message, wherein one of the first signature generation apparatus or the second signature generation apparatus generates a signature for the message using the first distributed signature or the second distributed signature.

### CROSS REFERENCE TO RELATED APPLICATIONS

This application is based upon and claims the benefit of the priority of Japanese patent application No. 2024-155250, filed on Sep. 9, 2024, the disclosure of which is incorporated herein in its entirety by reference thereto.

### FIELD

The present disclosure relates to a digital signature system, method and non-transitory medium.

### BACKGROUND

Digital signature is a technology which enables to verify a creator of an electronic document and check that the document has not been altered after creation thereof.

A digital signature algorithm typically includes a sequence of fundamental processes: key generation, signing, and verification.
Key generation: A set of a signing key (secret key) sk and a verification key (public key) vk are generated.

$$( sk , vk ) ← KeyGen ( {1}^{κ} ) \qquad ( 1 )$$

where κ is a security parameter.

The key generation algorithm may be configured to, instead of receiving the security parameter, receive common (public) parameters generated from the security parameter by a setup algorithm to generate a set of a signing key (secrete or private key) sk and a verification key (public key) vk.
Signing: A signature σ for a message (document) m to be signed is generated with the signing key sk. More specifically, the signature σ with the signing key (secret key) sk is generated for the message m or a hash value obtained by applying a hash function to the message m.

$$σ ← Sign ( sk , m ) \qquad ( 2 )$$

Verification: Correctness of the message (document) m and the signature σ is verified, using the verification key vk.

$$0 / 1 ← Verify ( vk , m , σ ) \qquad ( 3 )$$

The function Verify ( ) performs verification all at once as to
1) whether the signature was generated using a signing key that corresponds to the verification key or not, and
2) whether the signature was generated for the message (document) or not,
   and returns 1 for acceptance and 0 for rejection.

Digital signatures using biometric information have been proposed as Fuzzy signatures, which includes a sequence of following processes:
Key generation: Using biometric information, a verification key is generated.
Signing: A signature σ for a message is generated using biometric information.
Verification: Correctness of the message and the signature is verified, using the verification key.

NPL (Non-Patent Literature) 1 discloses a fuzzy signature system with a distributed signature scheme in which one of distributed keys is replaced with biometric information.
[NPL 1] Haruna Higo, Toshiyuki Isshiki, Saki Otsuki, Kenji Yasunaga, “Fuzzy Signature with Biometric-Independent Verification”, 2023 International Conference of the Biometrics Special Interest Group (BIOSIG), IEEE, 20-22 Sep. 2023

### SUMMARY

A biometric-based distributed signature scheme has not been proposed in digital signature algorithms in which a signature is generated using secret information in addition to a signing key. As an example of such algorithms, there is EdDSA (Edwards-curve Digital Signature Algorithm), which is included in the CRYPTREC Ciphers List.

One of the purposes of the present disclosure is to provide a system, method, and non-transitory medium, each enabling to solve at least the above issue.

According to an embodiment of the disclosure, there is provided a digital signature system including a first signature generation apparatus and a second signature generation apparatus, each including at least a processor; a memory storing a program executable by the processor; and a communication interface, communicatively connectable to each other.

The processor included in the first signature generation apparatus is configured to:
acquire and store in a storage:
   a first helper key generated using first secret information corresponding to a verification key and first biometric information;
   helper data generated using second secret information for distributed signature generation and the first biometric information; and
   third secret information for distributed signature generation;
generate a second distributed key; and
generate a second distributed signature for a message to be signed, by using the second distributed key and the third secret information and sending/receiving information with the second signature generation apparatus.

The processor included in the second signature generation apparatus is configured to:
acquire second biometric information;
acquire the helper data,
restore the second secret information using the second biometric information and the helper data;
generate a first distributed key; and
generate the first distributed signature for the message, by using the first distributed key and the second secret information and sending/receiving information with the first signature generation apparatus.

The processor included in one of the first signature generation apparatus or the second signature generation apparatus is configured to
generate a signature for the message using:
one of the first distributed signature or the second distributed signature generated by the one of the first signature generation apparatus or the second signature generation apparatus; and
other of the first distributed signature or the second distributed signature generated by other of the first signature generation apparatus or the second signature generation apparatus.

A digital signature method according to an embodiment of the disclosure includes:
by a first apparatus:
   acquiring and storing in a storage:
      a first helper key generated using first secret information corresponding to a verification key and first biometric information;
      helper data generated using second secret information for distributed signature generation and the first biometric information; and
      third secret for information distributed signature generation;
   generating a second distributed key; and
   generating a second distributed signature for the message to be signed by using the second distributed key and the third secret information, and sending/receiving information with a second apparatus. The method includes:
by the second apparatus:
   acquiring the second biometric information;
   acquiring the helper data;
   restoring the second secret information using the second biometric information and the helper data;
   generating a first distributed key; and
   generating a first distributed signature for the message, by using the first distributed key and the second secret information and sending/receiving information with the first apparatus.
      The method includes:
by one of the first apparatus or the second apparatus,
   generating a signature for the message using:
   one of the first distributed signature or the second distributed signature generated by the one of the first apparatus or the second apparatus; and
   other distributed signature generated by other of the first apparatus or the second apparatus.

According to an embodiment of the disclosure, there is provided a non-transitory storage medium storing a program causing a first processing apparatus to execute processing including:
acquiring and storing in a storage:
   a first helper key generated using first secret information corresponding to a verification key and first biometric information;
   helper data generated using second secret information for distributed signature generation and the first biometric information; and
   third secret information for distributed signature generation;
generating a second distributed key; and
generating a second distributed signature for the message to be signed by using the second distributed key and the third secret information and sending/receiving information with a second processing apparatus.
   The non-transitory storage medium stores a program causing a second processing apparatus to execute processing including:
acquiring the second biometric information;
acquiring helper data generated using second secret information and first biometric information;
restoring the second secret information using the second biometric information and the helper data;
generating the first distributed key; and
generating the first distributed signature for the message by using the first distributed key and the second secret information and sending/receiving information with the first processing apparatus.
   The non-transitory storage medium stores the program causing one of the first processing apparatus or the second processing apparatus to execute processing including
generating a signature for the message using:
one of the first distributed signature or the second distributed signature generated by the one of the first processing apparatus or the second processing apparatus; and
other of the first distributed signature or the second distributed signature generated by other of the first processing apparatus and the second processing apparatus.

According to the present disclosure, a biometric distributed signature scheme can be realized for a digital signature scheme in which a signature is generated using secret information in addition to a signing key.

### BRIEF DESCRIPTION OF DRAWINGS

FIGS. 1A, 1B and 1C are diagrams illustrating EdDSA.

FIGS. 2A and 2B are diagrams illustrating Two party EdDSA.

FIG. 3 is a diagram illustrating a system example of at least one of embodiments of the disclosure.

FIG. 4 is a diagram illustrating a configuration example of each apparatus of at least one of embodiments of the disclosure.

FIG. 5 is a diagram illustrating an operation example of at least one of embodiments of the disclosure.

FIG. 6 is a diagram illustrating an operation example of at least one of embodiments of the disclosure.

FIG. 7 is a diagram illustrating a configuration example of each apparatus of at least one of embodiments of the disclosure.

FIG. 8 is a diagram illustrating a configuration example of each apparatus of at least one of embodiments of the disclosure.

FIG. 9 is a diagram illustrating an operation example of at least one of embodiments of the disclosure.

FIG. 10 is a diagram illustrating an operation example of at least one of embodiments of the disclosure.

FIG. 11A and FIG. 11B illustrate implementation examples in a computer.

### DETAILED DESCRIPTION

The following describes embodiments of the present disclosure. EdDSA, a signature scheme included in the CRYPTREC Ciphers List, uses an elliptic curve ((twisted) Edwards curve) on a finite field GF (p) (where p is an odd prime number, p=2\hat{ }255−19 for Ed25519 and p=2\hat{ }488−2\hat{ }244−1 for Ed488, where the caret (\hat{ }) is used as an exponentiation operator). A signing key (secret key for signing) sk includes two secret information, i.e., secret information s (secret key) corresponding to a verification key vk, which is a public key, and secret information s′ which is used for nonce generation in a signing phase. The secret information s′ for nonce generation is used to calculate a hash value in signature generation. A hash function used in EdDSA is SHA-512 in Ed25519 and SHAKE25 in Ed448, neither of which is homomorphic. Thus, the hash value thereof cannot be computed using a two party distributed signing protocol. Therefore, when considering an application of EdDSA to a two-party distributed signature scheme, it is necessary to manage the secret information s′ for nonce generation on a signer side, as described below.

There has been proposed no distributed signature generation technology using biometric information with which the signer' side won't need to manage such secret information (secret information s (secret key) and secret information s′ for nonce generation).

The above issue is only an example, but the present disclosure proposes a biometric-based distributed signature scheme that addresses at least the above issue.

According to systems (methods) presented in the present disclosure, a first helper key (c) generated using first secret information (secret key) (s) corresponding to a verification key and first biometric information (w) is registered (stored and retained) in a key-based signature generation apparatus (first signature generation apparatus). As for second secret information (s′₁) used in generation of a distributed signature, helper data (c₁) generated using the second secret information (s′₁) and the first biometric information (w) are registered (stored and retained) in the key-based signature generation apparatus. In addition, third secret information (s′₂) used in the generation of the distributed signature is registered (stored and retained) in the key-based signature generation apparatus.

The biometric-based signature generation apparatus (second signature generation apparatus) acquires second biometric information (w′) in a signing phase, acquires the helper data (c₁) from the key-based signature generation apparatus (first signature generation apparatus), and restores the second secret information (s′₁) using the second biometric information (w′) and the helper data (c₁). The biometric-based signature generation apparatus may further generate a first distributed key (either one of Δ or x′) and execute process for generating a first distributed signature for a message (m: electronic document) to be signed, by using the first distributed key and the second secret information (s′₁) and sending/receiving information with the key-based signature generation apparatus.

The key-based signature generation apparatus (first signature generation apparatus) may generate a second distributed key (the other of Δ or x′) in the signing phase. The key-based signature generation apparatus may, by using the second distributed key and the third secret information (s′₂) and sending/receiving information with the biometric-based signature generation apparatus (second signature generation apparatus) to generate a second distributed signature for the message (m).

One of the key-based signature generation apparatus (first signature generation apparatus) or the biometric-based signature generation apparatus (second signature generation apparatus) may generate a signature for the message (m) using one of the first and second distributed signatures generated by its own apparatus and the other distributed signature generated by the other apparatus.

The biometric-based signature generation apparatus (second signature generation apparatus) may generate a second helper key (c′) using the first distributed key (Δ) and the second biometric (w′), and send the second helper key (c′) to the key-based signature generation apparatus (first signature generation apparatus), which receives the second helper key (c′) to generate a second distributed key (x′) using the first helper key (c) and the second helper key (c′).

The key-based signature generation apparatus (first signature generation apparatus) may generate the second helper key (c′) using the helper data (c1) and the second distributed key (Δ), and send the second helper key to the biometric-based signature generation apparatus (second signature generation apparatus), which receives the second helper key (c′) to generate the first distributed key (x′) using the second helper key (c′) and the second biometric information (w′).

The following describes an overview of EdDSA, as a premise of an example scheme of the present disclosure.

Using a system common parameter para: {b, p, a, d, c, L, n, B, H, E, PH} of EdDSA (reference may be made to, for example, Reference Literature 1 or Request for Comments (RFC) 8032 for details), (Twisted) Edwards curve is defined as below.

$$E ( p , a , d ) := \{ ( x , y ) ∈ Fp \times Fp \vert {ax}^{2} + {y}^{2} = 1 + {dx}^{2} {y}^{2} \} \qquad ( 4 )$$

An output length of H:{0,1}*→{0,1}^{2b} is 2b bits, where the followings hold:

$$p < {2}^{b - 1} , c < n < b ( c = 2 or 3 ) , {2}^{( b - c - 1 )} < 1 < {2}^{( b - c} ) \qquad ( 5 )$$

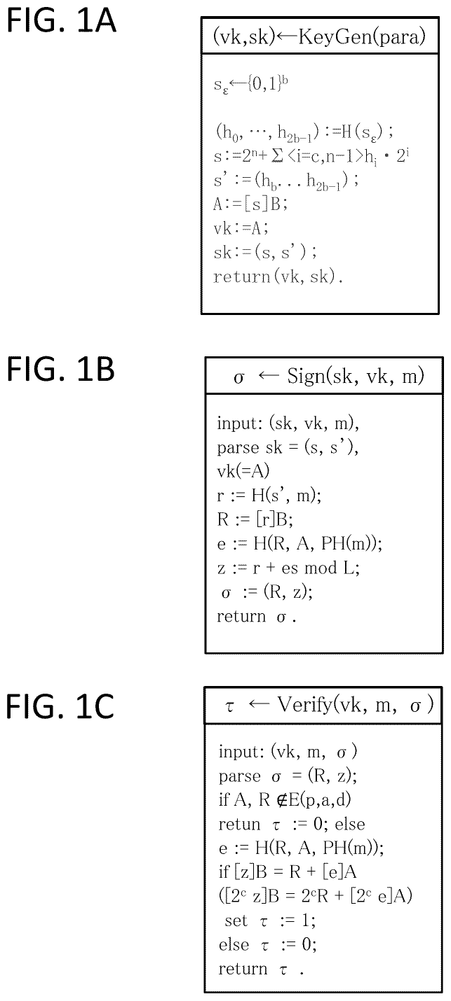

Three protocols of EdDSA: key generation (KeyGen), signing (Sign), and verification (Verify) include algorithms shown in FIGS. 1A, 1B, and 1C, respectively (based on Reference Literature 1).

The key generation algorithm KeyGen in FIG. 1A takes the parameter para as input, generates the signing key sk and the verification key vk, and returns them as a return value (return (vk, sk)).

KeyGen generates a random number se of b-bit length. In more detail, a bit sequence of b-bits is generated uniformly at random from {0,1} and set to s_{ε}.

$${s}_{ε} ← {\{ 0 , 1 \}}^{b} \qquad ( 6 )$$

KeyGen generates a bit sequence of 2b-bits (h₀, . . . h_{2b-1}) by a hash function H (output length of His 2b bits).

$$( {h}_{0 ..} , {h}_{2 b - 1} ) := H ( {s}_{ε} ) \qquad ( 7 )$$

s is a (n+1)-bit length secret information with the most significant bit ((n+1)-bit) being 1, i-bit (=c, . . . , n−1) being hi and the lower c-bit being 0.

$$s := {2}^{n} + \sum < i = c , n - 1 > {h}_{i} \cdot {2}^{i} \qquad ( 8 )$$

s′ is upper b-bit length secret information of H (s_{ε}).

$${s}^{′} := ( {h}_{b} … {h}_{2 b - 1} ) \qquad ( 9 )$$

The verification key vk of the signature is given as

$$vk := A ( = [ s ] B ) \qquad ( 10 )$$

with a bit length b, where B is a generator (with a prime order L) of the group (a base point of the elliptic curve). That is,

$$[ L ] B = O \qquad ( 11 )$$

The left-hand side of Equation (11) represents

$$[ L ] B = {\overbrace{B + … +}}^{L} B$$

(where [L]B is a notation used in RFC8032) and O is a zero element of the group operation.

The signing key sk=(s, s′) is (b+n+1) bits long.

A signature generation algorithm: Sign in FIG. 1B takes (sk, vk, m) as input and returns a signature σ as a return value, which is almost equivalent to a Schnorr signature, but unlike the Schnorr signature, instead of randomly generating an internal random number r, Sign generates a hash value of secret information s′ and a plaintext to be signed (message) m (by concatenating s′ and m) to be as a nonce r.

$$r := H ( {s}^{′} , m ) \qquad ( 12 )$$

In Sign, the base point B is added r times to obtain R.

$$R := [ r ] B \qquad ( 13 )$$

Next, R and the verification key vk (=A) are concatenated with PH(m) (R∥A∥PH(m)) and a hash value thereof is computed.

$$e := H ( R , A , PH ( m ) ) \qquad ( 14 )$$

The pre-hash function PH is an identity function: PH(m)=m for PureEdDSA, while PH(m)=H′(m) (hash value of m) for HashEdDSA.

As in a normal Schnorr signature, r is added to e multiplied by the secret information s (modulo operation with a modulo L).

$$z := r + e * s mod L \qquad ( 15 )$$

A signature verification algorithm denoted as Verify in FIG. 1C takes (vk, m, σ) as input and returns a verification result t as a return value.

If A and R are not contained in E(p, a, d), Verify returns τ=0, i.e., if A, R∉E (p, a, d), then return τ:=0; else

$$e := H ( R , A , PH ( m ) )$$

Equivalent to signature verification for the Schnorr signature, but in RFC8032, in verification of a signature (R,z), instead of

$$[ z ] B = R + [ e ] A \qquad ( 16 )$$

the following is used.

$$[ 2 \hat{} cz ] B = [ 2 \hat{} c ] R + [ 2 \hat{} ce ] A \qquad ( 17 )$$

where the caret (\hat{ }) is used as an exponentiation operator, and B is a base point of the elliptic curve (cyclic group of a prime order L).

If a legitimate signer has created the signature, A, R∈<B> holds, and [z]B=R+[e]A also holds. But, we use the following as a verification equation:

$$[ 2 \hat{} cz ] B = [ 2 \hat{} c ] R + [ 2 \hat{} ce ] A$$

$$If [ 2 \hat{} cz ] B = [ 2 \hat{} c ] R + [ 2 \hat{} ce ] A holds , then τ = 1 , else τ := 0.$$

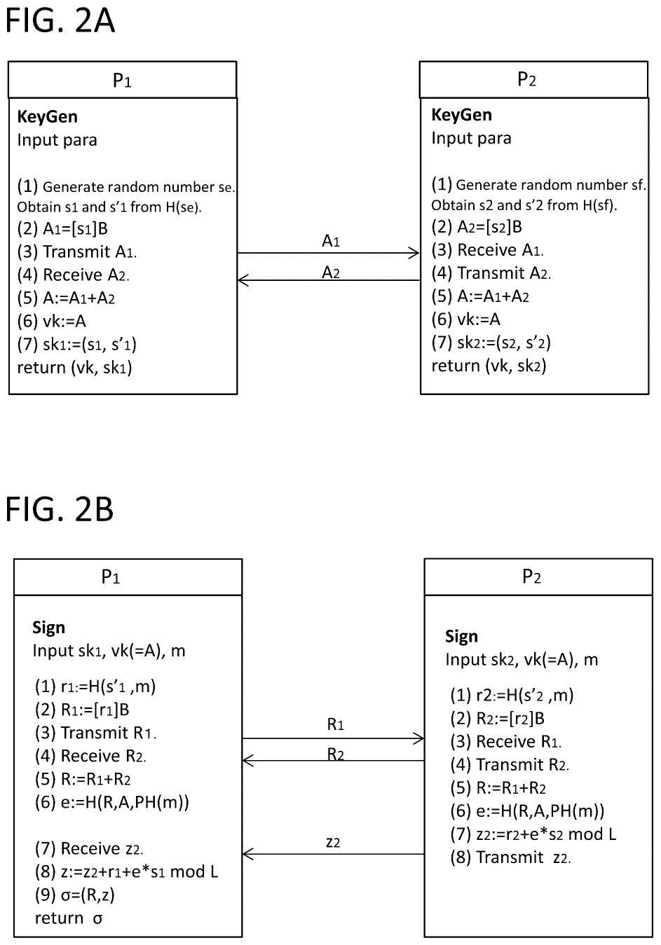

In the following, we consider a two-party distributed signature with respect to EdDSA. FIG. 2 illustrates the two-party distributed signature between P1 and P2 (based on the disclosure in Reference literature 2 and a study of the inventor and others). In P1 and P2, the numbers in parentheses represent the step numbers in each apparatus (unit), but it is noted that there may be cases where the steps are not performed in this order.

In P1, key generation (KeyGen) is performed as shown in FIG. 2A.
(1) With the parameter para as input, a b-bit length random number se is generated and a 2b bit sequence is generated by the hash function H

$$( {h}_{0} … {h}_{2 b - 1} ) \text{=:} H ( {s}_{e} ) \qquad ( 18 )$$

Out of the 2b bit sequence, the first distributed key s1 of (n+1) bit length where the (n+1)th bit is 1, i bits are hᵢ (i=c, . . . , n−1), and lower c bits are 0 is obtained.

$${s}_{1} := {2}^{n} + \sum < i = c , n - 1 > {h}_{i} \cdot {2}^{i} \qquad ( 19 )$$

The first distributed key s₁ of (n+1) bit length where out of the 2b bit sequence, the (n+1)th bit is 1, i bits are hᵢ (i=c, . . . , n−1), and lower c bits are 0 is obtained. The first distributed secret information s′₁ is secret information for first nonce generation.

$${s}_{1}^{′} := ( {h}_{b} … {h}_{2 b - 1} ) … \qquad ( 20 )$$

(2) Compute A₁=[s1]B.
(3) Transmit A₁ to P2.
(4) Receive A₂(=[s₂]B) from P2.
(5) Add rational points A₁ and A₂ on the elliptic curve to obtain a rational point A on the elliptic curve.

$$A = {A}_{1} + {A}_{2} = [ {s}_{1} ] B + [ {s}_{2} ] B = [ {s}_{1} + {s}_{2} ] B \qquad ( 21 )$$

(6) Let A be a verification key vk.
(7) Let (s₁, s′₁) be a distributed signature secret key sk₁.

It is noted that step (3) may be omitted and A obtained in step (5) may be transmitted to P2.

Similar to P1, P2 performs the key generation (KeyGen) shown in FIG. 2A.
(1) With the parameter para as input, a bit-length random number s_{f} is generated and generate a 2b bit sequence is generated by the hash function H

$$( {h}_{0}^{′} … {h}_{2 b - 1}^{′} ) \text{=:} H ( {s}_{f} ) \qquad ( 22 )$$

The second distributed key s₂ of (n+1) bit length where out of the 2b bit sequence, the (n+1)th bit is 1, i bits are hᵢ (i=c, . . . , n−1), and lower c bits are 0 is obtained.

$${s}_{2} := {2}^{n} + \sum < i = c , n - 1 > {h}_{i}^{′} \cdot {2}^{i} \qquad ( 23 )$$

The second distributed secret information s′₂ is the upper b-bit length of H(s_{f}).

$${s}_{2}^{′} := ( {h}_{b}^{′} … {h}_{2 b - 1}^{′} ) \qquad ( 24 )$$

(2) Compute A₂=[s₂]B.
(3) Receive A₁(=[s₁]B) from P1.
(4) Transmit A₂ to P1.
(5) Add the rational points A₁ and A₂ on the elliptic curve to obtain A on the elliptic curve.

$$A = {A}_{1} + {A}_{2} = [ {s}_{1} ] B + [ {s}_{2} ] B = [ {s}_{1} + {s}_{2} ] B \qquad ( 25 )$$

(6) Let A be a verification key vk.
(7) Let (s2, s′2) be a distributed signature secret key sk₂.

It is noted that step (3) may be deleted and A transmitted from P1 may be received instead of step (5).

In a signing phase, P1 performs distributed signature generation (Sign) as shown in FIG. 2B.

The distributed signature generation (Sign) may take the verification key vk (=A), the distributed signature secret key sk₁ (=(s₁, s′₁)), and the message m, as inputs, and may perform following steps.
(1) Compute a first nonce r₁ (integer), which is a hash value of the first distributed secret information s′₁ and message m. That is, the first nonce r₁ is a hash value obtained by concatenating s′₁ and m and then inputting the concatenated result to the hash function H.

$${r}_{1} := H ( {s}_{1}^{′} , m ) \qquad ( 26 )$$

(2) Compute a first rational point R₁ on the elliptic curve using the first nonce r₁.

$$R 1 := [ {r}_{1} ] B \qquad ( 27 )$$

(3) Transmit R₁ to P2.
(4) Receive R₂ from P2.

It is noted that step (4) may be performed before step (3), as long as it is before step (5).
(5) Add the first rational point R₁ and the second rational point R₂ on the elliptic curve to obtain a third rational point R.

$$R := {R}_{1} + {R}_{2} = [ {r}_{1} + {r}_{2} ] B \qquad ( 28 )$$

(6) Concatenate the third rational point R and the verification key vk(=A) with PH(m) and input the concatenated result into the hash function H to obtain a hash value e.

$$e := H ( R , A , PH ( m ) ) \qquad ( 29 )$$

(7) Receive z₂ from P2.
(8) Using z₂, e and s₁, compute

$$z := {z}_{2} + {r}_{1} + e * {s}_{1} mod L \qquad ( 30 )$$

(9) Compute a signature σ:=(R,z) and set the signature σ(=(R,z)) to be a return value.

It is noted that step (3) may be omitted and R obtained in step (5) may be transmitted to P2.

P2 performs distributed signature generation (Sign) as shown in FIG. 2B. The distributed signature generation (Sign) may take the verification key vk (=A), the distributed signature secret key sk₂ (=(s₂, S′₂)), and the message m, as inputs, and may perform following steps.
(1) Compute a second nonce r₂ (integer), which is a hash value of the second distributed secret information s′₂ and message m. That is, the second nonce r₂ is a hash value obtained by concatenating s′₂ and m and inputting the concatenated result into the hash function H.

$${r}_{2} := H ( {s}_{2}^{′} , m ) \qquad ( 31 )$$

(2) Compute a second rational point R₂ on the elliptic curve.

$${R}_{2} := [ {r}_{2} ] B \qquad ( 32 )$$

(3) Receive the first rational point R₁ on the elliptic curve from P1.
(4) Transmit the second rational point R₂ on the elliptic curve to P1.

It is noted that Step (3) and (4) do not have to be in this order.
(5) Add the first rational point R₁ and the second rational point R₂ on the elliptic curve to obtain the third rational point R on the elliptic curve.

$$R := {R}_{1} + {R}_{2} = [ {r}_{1} + {r}_{2} ] B \qquad ( 33 )$$

(6) Concatenate the third rational point R on the elliptic curve and the signature verification key vk(=A) to PH(m) and input the concatenated result into the hash function H to obtain a hash value e.

$$e := H ( R , A , PH ( m ) ) \qquad ( 34 )$$

$$( 7 ) Compute {z}_{2} := {r}_{2} + e * {s}_{2} mod L \qquad ( 35 )$$

(8) Transmit z₂ to P1.

It is noted that step (3) may be deleted, and instead of step (5), R transmitted from P1 may be received.

As for the signature σ=(R,z), Equation (30) is expressed as follows.

$$z := {z}_{2} + {r}_{1} + e * {s}_{1} = {r}_{2} + e * {s}_{2} + {r}_{1} + e * {s}_{1} \qquad ( 36 )$$

$$= {r}_{1} + {r}_{2} + e * ( {s}_{1} + {s}_{2} ) = {r}_{1} + {r}_{2} + e * s mod L$$

where z composes the signature σ=(R, z) for message m with the secret key (s=s₁+s₂) and the secret information s′₁ and s′₂.

The verification apparatus receives the signature σ from P1 and executes the verification algorithm Verify, which takes the verification key vk, message m, and signature σ as inputs and checks if the following holds.

$$[ {2}^{⋀} cz ] B = [ {2}^{⋀} c ] R + [ {2}^{⋀} ce ] A \qquad ( 37 )$$

For example, if c=3,

$$[ 8 z ] B = [ 8 ] R + [ 8 e ] A \qquad ( 38 )$$

In FIGS. 2, P1 and P2 perform key generation (KeyGen), respectively, but not limited thereto. For example, the key generation (i.e., generation of vk, sk₁ and sk₂) may be performed for P1 and P2 by entities different from P1 and P2 (such as the first and second key generation apparatuses).

In the example in FIG. 2, the distributed signature secret key sk₁=(s₁, s′₁) needs to be managed on the P1 side. It is noted that Reference Literature 2 does not disclose biometric-based distributed signature in which distributed keys based on biometric information are used to generate a signature between two parties in a distributed manner. However, in biometric-based distributed signature, P1 needs to manage at least the secret information s′₁, as in FIG. 2. When P1 is a client, management of the secret information s′₁ may become a burden on the client.

The above issue is just one example. The present disclosure proposes a new digital signature system (biometric-based distributed signature system) that can at least address the above issue.

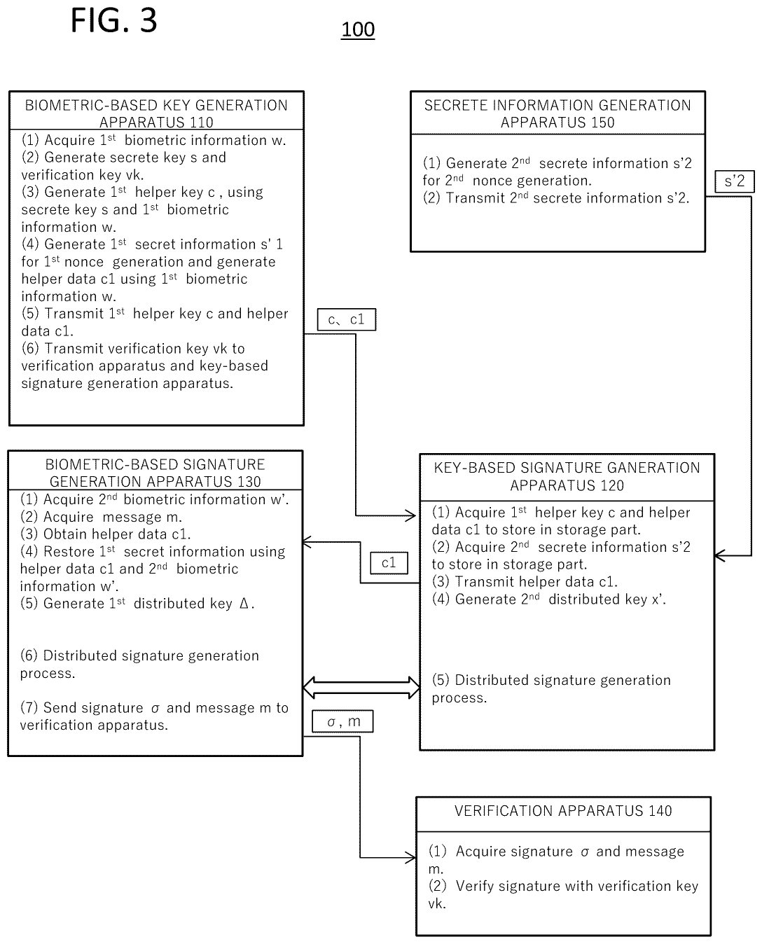

FIG. 3 illustrates one of embodiments of the digital signature system proposed in the present disclosure. Referring to FIG. 3, the digital signature system 100 includes a biometric-based key generation apparatus 110, a key-based signature generation apparatus 120, a biometric-based signature generation apparatus 130, a verification apparatus 140, and a secret information generation apparatus 150. In FIG. 3, numbers in parentheses of each apparatus represent the number of processing steps, but the order of processing is not necessarily limited to that order. In FIG. 3, the sending and receiving of signals are indicated by arrows, but this does not imply unidirectional transmission and may include, for example, such a series of handshakes including transmission of a request for acquiring information from a reception apparatus to a sending apparatus, transmission of information from the transmission apparatus to the reception apparatus, and transmission of an acknowledgment from the reception apparatus to the sending apparatus, or, such a series of handshakes including transmission of a transmission request from a transmission apparatus to a reception apparatus, transmission of an acknowledgement from the reception apparatus to the transmission apparatus, transmission of information from the transmission apparatus to the reception apparatus, and transmission of an acknowledgement from the reception apparatus to the transmission apparatus. The same applies to the following drawings.

The biometric-based key generation apparatus 110 may perform, as a part of the key generation algorithm, for example, following steps.
(1) Acquire first biometric information w of a user.
(2) Generate a secret key (secret information) s and a verification key vk (=A=[s]B) corresponding to the secret key s, which is a public key. The private key (secret information) s may be generated by Equation (8). The verification key vk may be generated by Equation (10).
(3) Generate a first helper key c using the private key (secret information) s corresponding to the verification key vk and the first biometric information w. The first helper key c may be a sketch (secure sketch) that is a composite of an encoded value ENC(s) of the private key (secret information) s and the first biometric information w, where ENC(s) represents the encoded value obtained by an encoding function ENC with s inputted thereinto.

$$c := ENC ( s ) + w \qquad ( 39 )$$

It is noted that on the right side of Equation (39), addition is used as a composition operation, but an operation such as subtraction and bit-wise exclusive OR may be used. For example, when w is binary data, c may be obtained by bit-wise exclusive OR operation with ENC(s).
(4) Generate the first secret information s′i for the first nonce generation. The first secret information s′i may be computed, for example, using Equation (9). The first biometric information w is used to generate helper data c₁. The helper data c₁ may be a composition of the encoded value ENC(s′₁) of the first secret information s′i and the first biometric information w.

$${c}_{1} := ENC ( {s}_{1}^{′} ) + w \qquad ( 40 )$$

It is noted that on the right side of equation (40), as in Equation (39), a composition operation is not limited to addition, but an operation such as subtraction and bit-wise exclusive OR may be used.
(5) The first helper key c and helper data c₁ are transmitted to the key-based signature generation apparatus 120. Although c may be referred to as helper data, it is referred as a helper key to distinguish it from the helper data c₁. c is also referred to as the first helper key to distinguish it from c′ below.
(6) The verification key vk (=A) is transmitted to the verification apparatus 140. The verification key vk is also transmitted to the key-based signature generation apparatus 120. This is because the verification key vk (=A) is used in signing phase (signature generation). The verification key vk (=A) may be one of common parameters that can be commonly referenced by the key-based signature generation apparatus 120 and the biometric-based signature generation apparatus 130.

The secret information generation apparatus 150 may perform, as a part of the key generation algorithm, for example, following steps.
(1) Generate second secret information s′₂ for second nonce generation. The second secret information s′₂ may be generated, for example, using Equation (24).
(2) The second secret information s′2 is transmitted to the key-based signature generation apparatus 120. The secret key s may be denoted as the first secret information. In this case, the above first secret information s′₁ and second secret information s′₂ may be designated as the second and third secret information.

When generation a signature, the biometric-based signature generation apparatus 130 may perform, for example, following steps.
(1) Acquire second biometric information w′ of a user (signer).
(2) Acquire a message m to be signed.
(3) Receive helper data c₁ from the key-based signature generation apparatus 120.
(4) Restore the first secret information s′i using the helper data c₁ and the second biometric information w′. For example, the first secret information s′₁ may be restored by inputting a difference between c₁ and w′ into a decoding function DEC.

$${s}^{′} 1 := DEC ( {c}_{1} - {w}^{′} ) \qquad ( 41 )$$

The right side of Equation (41) is expressed as

$$DEC ( {c}_{1} - {w}^{′} ) = DEC ( ENC ( {s}_{1}^{′} ) + ( w - {w}^{′} ) ) \qquad ( 42 )$$

Modalities of the first biometric information w and the second biometric information w′ are set to be identical (e.g., sensors that acquire the first biometric information w and the second biometric information w′ are the same model). When a difference between w and w′ may be less than an error correction range of the decoding function DEC, and the following holds:

$$DEC ( {c}_{1} - {w}^{′} ) = {s}_{1}^{′} \qquad ( 43 )$$

The biometric-based signature generation apparatus 130 receives the helper data c₁ from the key-based signature generation apparatus 120 each time it creates a signature and obtains the first secret information s′₁ by decoding a difference between the helper data c₁ and the second biometric information w′. It is unnecessary for the biometric-based signature generation apparatus 130 to manage the first secret information s′₁. The first secret information s′i is obtained by decoding the difference between the helper data c₁ and the second biometric information w′.
(5) Select a first distributed key Δ (integer) uniformly at random from an information source.

Generate a second helper key c′ using the first distributed key Δ and the second biometric information w′.

$${c}^{′} := ENC ( Δ ) + {w}^{′} \qquad ( 44 )$$

Transmit the second helper key c′ and a message m to the key-based signature generation apparatus 120. The message m may be transmitted to the key-based signature generation apparatus 120 after the message m is obtained in step (2).
(6) Perform the distributed signature generation process, by using the first secret information s′₁ and the first distributed key Δ, and sending/receiving information with the distributed signature generation process of the key-based signature generation apparatus 120, for example, as follows.

Generate the first nonce r₁=H (s′₁,m), using the first secret information s′₁ and the message m.

Compute the first rational point (R₁=[r₁]B) on the elliptic curve corresponding to the first nonce r₁.

Compute a third rational point R on the elliptic curve (R=R₁+R₂) which is a result of the addition on the elliptic curve line with a second rational point (R₂=[r₂]B) corresponding to the second nonce 2 received from the key-based signature generation apparatus 120.

Generate a first partial signature (first distributed signature) z₁(=r₁+e*Δ, where e:=H(R, A, PH(m))), using R, the first nonce r₁, the verification key vk(=A=[s]B), the message (m) and the first distributed key Δ.

Generate a signature σ=(R,z), where R is the third rational point on the elliptic curve and z is a composite value (z=r₁+r₂+e*(Δ+x′)) composed by the first partial signature z₁ and the second partial signature (second distributed signature) z₂ (=r₂+e*x′), where z₂ is generated in the key-based signature generation apparatus 120, by using R, the second nonce 12, the verification key vk (=A=[s]B), the message m and the second distributed key x′.
(7) Transmit the signature σ=(R, z) and the message m to the verification apparatus 140.

The key-based signature generation apparatus 120 may perform, for example, following steps.
(1) Receive the first helper key c and the helper data c₁ from the biometric-based key generation apparatus 110 and register them in a storage part. The first helper key c registered in the key-based signature generation apparatus 120 is an encoded value of the private key s corresponding to the verification key vk and embedded in the first biometric information. Thus, security against extraction and/or compromise of the private key s and/or first biometric information w from the first helper key c can be ensured. In addition, the helper data c₁ registered in the key-based signature generation apparatus 120 is the encoded value of the secret information s′₁ for the first nonce generation embedded in the first biometric information w, and security against extraction and/or compromise of the secret information s′₁ can also be ensured.
(2) Receive the second secret information s′₂ from the secret information generation apparatus 150 and register it in the storage part.
(3) Transmit the helper data c₁ to the biometric-based signature generation apparatus 130.
(4) Generate the second distributed key x′.

For example, the second helper key c′(=ENC (Δ)+w′) may be received from the biometric-based signature generation apparatus 130, and the second distributed key x′ may be generated, using the first helper key c and the second helper key c′.
(5) Perform distributed signature generation process, by using the second secret information s′2 and the second distributed key x′ and sending/receiving (exchanging) information with the distributed signature generation process of the biometric-based signature generation apparatus 130.

For example, the second nonce r₂=H(s′₂,m) may be generated using the second secret information s′₂.
the second rational point R₂=[r₂]B on the elliptic curve corresponding to the second nonce r₂ is computed,
the second rational point R₂ may be transmitted to the biometric-based signature generation apparatus 130, and
using the third rational point R(=R₁+R₂) which is a result of addition on the elliptic curve of the first rational point R₁ from the biometric-based signature generation apparatus 130 and the second rational point R₂, the verification key vk(=A=[s]B), the message m and the second distributed key x′, a second partial signature z₂(=r₂+e*x′, where e:=H(R, A, PH(m))) may be generated and transmitted to the biometric-based signature generation apparatus 130.

The verification apparatus 140 that verifies a signature for the message m using the verification key may perform, for example, following steps.
(1) Receive a signature σ=(R, z) and the message m from the biometric-based signature generation apparatus 130,
(2) Verifies whether or not σ=(R, z) and the message m are correct, using the verification key vk. The signature σ=(R, z) and message m may be received from the key-based signature generation apparatus 120.

In some implementations, the biometric-based signature generation apparatus 130, biometric-based key generation apparatus 110, and secret information generation apparatus 150 may be configured as client-side apparatuses connected by a network (e.g., wired or wireless LAN (Local Area Network), mobile communication network, etc.), respectively, and the key-based signature generation apparatus 120 may be configured as a server apparatus (e.g., cloud server, etc.) connected to the client-side apparatuses via a wired/wireless LAN, mobile communication network, WAN (Wide Area Network) such as The Internet, etc., though not limited thereto. Depending on the implementation, the secret information generation apparatus 150 may be configured as a server-side apparatus and as an entity independent of the key-based signature generation apparatus 120. For example, the server-side secret information generation apparatus 150 may receive a request from the client-side biometric-based key generation apparatus 110 to generate secret information s′₂ for transmission to the key-based signature generation apparatus 120.

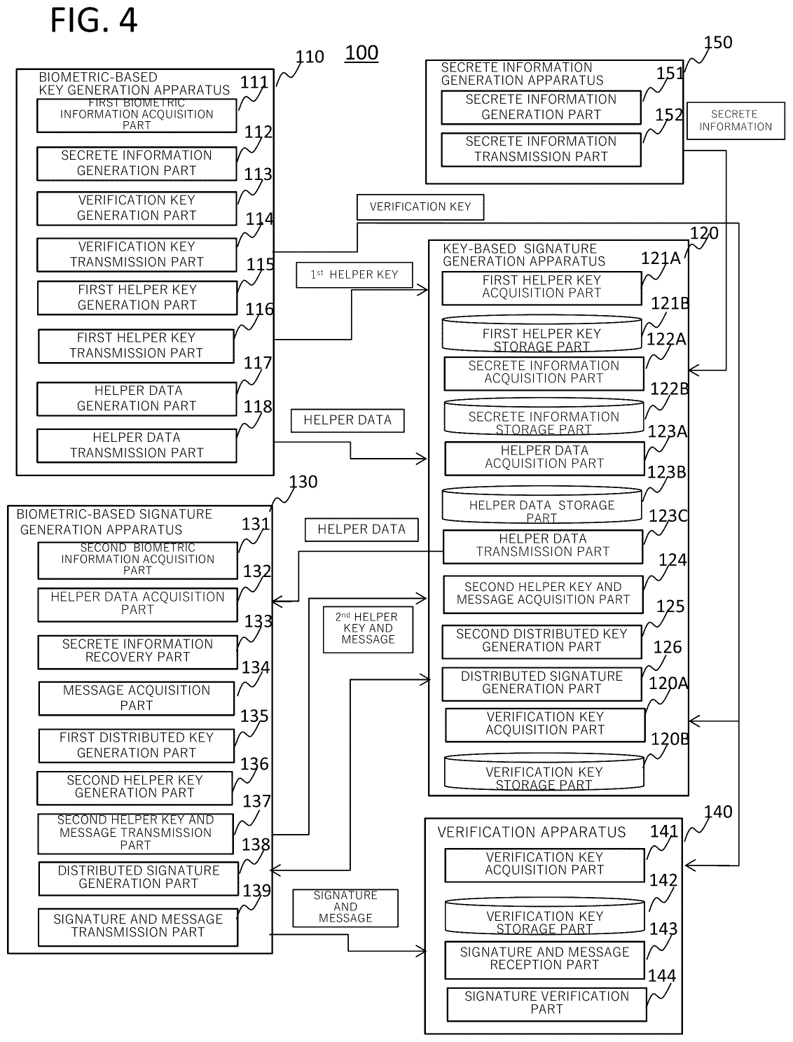

FIG. 4 illustrates an example of a functional configuration (functional blocks) of each apparatus included in the system 100 of FIG. 3. The biometric-based key generation apparatus 110 includes a first biometric information acquisition part 111, a secret information generation part 112, a verification key generation part 113, a verification key transmission part 114, a first helper key generation part 115, a first helper key transmission part 116, a helper data generation part 117 and a helper data transmission part 118.

The secret information generation apparatus 150 includes a secret information generation part 151 and a secret information transmission part 152.

The biometric-based signature generation apparatus 130 includes a second biometric information acquisition part 131, a helper data acquisition part 132, a secret information restoration part 133, a message acquisition part 134, a first distributed key generation part 135, a second helper key generation part 136, a second helper key and message transmission part 137, a distributed signature generation part 138, and a signature and message transmission part 139. The distributed signature generation part 138 uses the verification key vk (=A) to generate the distributed signature. A verification key acquisition unit (not shown) may be provided within the distributed signature generation part 138 that obtains the verification key vk (=A) from the key-based signature generation apparatus 120. A verification key acquisition unit (not shown) may be provided separately from the distributed signature generation part 138. It is unnecessary for the biometric-based signature generation apparatus 130 to receive the verification key vk generated by the biometric-based key generation apparatus 110 and to store and manage the verification key vk on the side of the biometric-based signature generation apparatus 130.

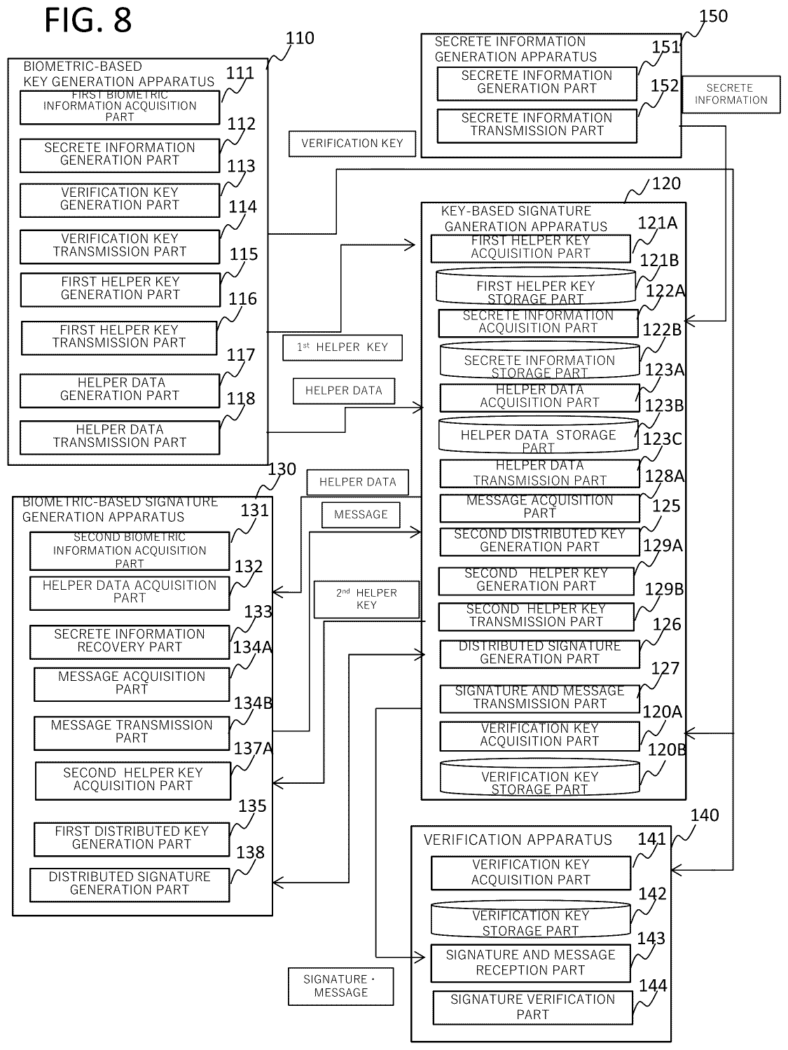

The key-based signature generation apparatus 120 includes a first helper key acquisition part 121A, a first helper key storage part 121B, a secret information acquisition part 122A, a secret information storage part 122B, a helper data acquisition part 123A, a helper data storage part 123B, a helper data transmission part 123C, a second helper key and message acquisition part 124, a second distributed key generation part 125, a distributed signature generation part 126, a verification key acquisition part 120A, and a verification key storage part 120B. Although not shown for drawing convenience, the key-based signature generation apparatus 120 may include a signature message transmission unit (127 in FIG. 8) that transmits a signature and a message to the verification apparatus 140, instead of the signature and message transmission part 139 included in the biometric-based signature generation apparatus 130.

The verification apparatus 140 includes a verification key acquisition part 141, a verification key storage part 142, a signature and message acquisition part 143, and a signature verification part 144.

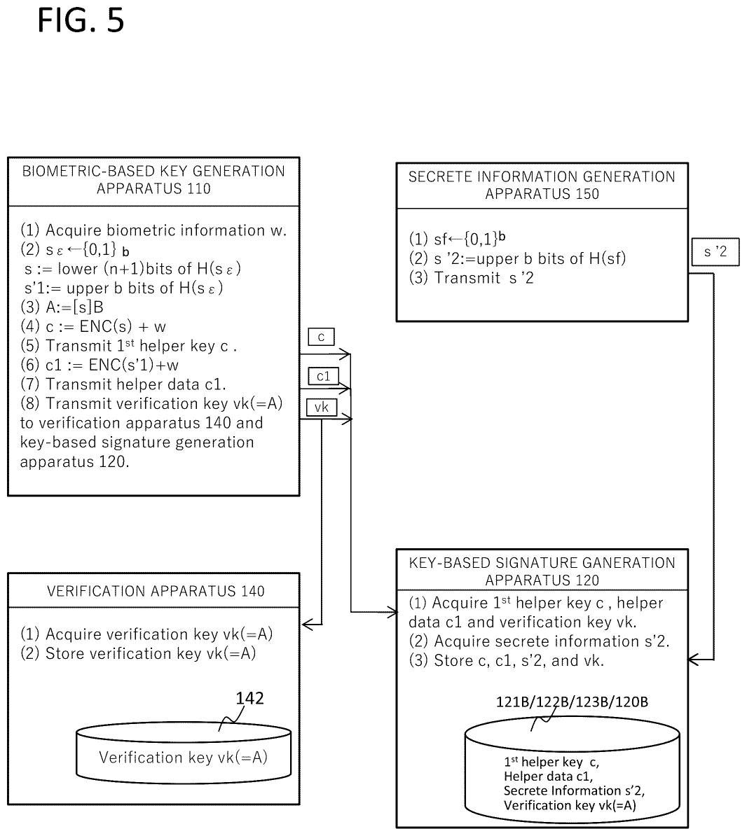

FIG. 5 illustrates the key (secret information) generation process in the system of FIG. 4. The numbers in parentheses for each apparatus in FIG. 5 are processing step numbers in each apparatus.

The biometric-based key generation apparatus 110 may perform, for example, following steps.
(1) The first biometric information acquisition part 111 acquires first biometric information w of a user. The first biometric information may be face information, fingerprint information, vein information (finger or palm), iris information, etc.
(2) The secret information generation part 112 generates a bit sequence (random number) of b-bits uniformly at random from {0,1} to s₂.

$${s}_{ε} ← {\{ 0 , 1 \}}^{b} \qquad ( 45 )$$

A bit sequence (h₀ . . . h_{2b-1}) of 2b bits is generated using the hash function H.

$$( {h}_{0} … , {h}_{2 b - 1} ) := H ( {s}_{ε} ) \qquad ( 46 )$$

s is a (n+1)-bit-long secret information with the most significant bit ((n+1)-bit) being 1, i-bit (=c, . . . , n−1) being hi and lower c-bit being 0.

$$s := 2 n + \sum < i = c , n - 1 > {h}_{i} \cdot {2}^{i} \qquad ( 47 )$$

s′1 is the upper b-bit length secret information of H(s_{ε}).

$${s}_{1}^{′} := ( {h}_{b} … {h}_{2 b - 1} ) \qquad ( 48 )$$

(3) The verification key generation part 113 generates the verification key vk using the secret information s (secret key) and a base point B of the elliptic curve.

$$vk := A = [ s ] B \qquad ( 49 )$$

(4) The first helper key generation part 115 generates the first helper key c using the encoded value ENC(s) of the secret information s (secret key) and the first biometric information w.

$$c := ENC ( s ) + w \qquad ( 50 )$$

The operation + may be − or may be a bit-by-bit exclusive or operation, etc., depending on the encoding.

The encoding function ENC converts a plaintext mA in an information source space to a code cA. The decoding function DEC converts the code cA back to the plaintext mA.

$$cA ← ENC ( mA ) \qquad ( 51 )$$

$$mA ← DEC ( cA ) \qquad ( 52 )$$

The following needs to hold for any code cA′, a difference of which from cA, i.e., the code of the plaintext mA contained in the information source space, is within a correction range (capability).

$$mA = DEC ( {cA}^{′} ) \qquad ( 53 )$$

In the following, a linear code is used.

### Linearity:

$$ENC ( m A ) + C ( mB ) \qquad ( 54 )$$

is a code word for mA+mB, and

$$m A + mB = DEC ( ENC ( mA ) + ENC ( mB ) \qquad ( 55 )$$

In Equation (55), the “+” on the left and right sides need not be the same operation.

With respect to coding, for example, an error-correcting code (Hamming code, BCH (Bose-Chaudhuri-Hocquenghem) code, RS (Reed-Solomon) code, LDPC (low-density parity-check code) code, etc.) may be used. Alternatively, lattice coding, for example, may be used. More specifically, a method using an integer lattice, a triangular lattice, or a more complex lattice may be used.

When the biometric information w is n-bit binary data, the encoded value ENC(s) may be n-bit binary data.

When the biometric information w is an n-dimensional vector, the encoded value ENC(s) may be an n-dimensional vector.
(5) The first helper key transmission part 116 transmits the first helper key c to the key-based signature generation apparatus 120.
(6) The helper data generation part 117 generates helper data c₁ using the encoded value ENC (s′₁) of the secret information s′i and the first biometric information w.

$${c}_{1 :} = ENC ( {s}_{1}^{′} ) + w \qquad ( 56 )$$

(7) The helper data transmission part 118 transmits helper data c₁ to the key-based signature generation apparatus 120.
(8) The verification key transmission part 114 transmits the verification key vk (=A=[s]B) to the verification apparatus 140. The verification key transmission part 114 may also transmit the verification key vk(=A=[s]B) to the key-based signature generation apparatus 120.

The first helper key c and helper data c₁ may be transmitted together or separately. The order of transmission of the verification key vk, the first helper key c and helper data c₁ is arbitrary.

The secret information generation apparatus 150 may perform, for example, following steps.
(1) Secret information generation part 151 generates a bit sequence (random number) of b-bits uniformly at random from {0,1} and sets it to s_{f}.

$${s}_{f} ← {\{ 0 , 1 \}}^{b} \qquad ( 57 )$$

A bit sequence (h₀ . . . h_{2b-1}) of 2b bits is generated using the hash function H.

$$( {h}_{0}^{′} … {h}_{2 b - 1}^{′} ) := H ( {s}_{f} ) \qquad ( 58 )$$

$${s}_{2}^{′} := ( {h}_{b}^{′} … {h}_{2 b - 1}^{′} ) \qquad ( 59 )$$

where s′₂ is the upper b-bits of the bit sequence (h₀ . . . h_{2b-1}).
(2) The secret information generation part 151 transmits the secret information s′₂ for second nonce generation to the key-based signature generation apparatus 120.

The verification apparatus 140 may perform, for example, following steps.
(1) The verification key acquisition part 141 receives the verification key transmitted from the biometric-based key generation apparatus 110.
(2) The verification key acquisition part 141 stores the verification key in the verification key storage part 142.

The key-based signature generation apparatus 120 may perform, for example, following steps.
(1) The first helper key acquisition part 121A, helper data acquisition part 123A and verification key acquisition part 120A receive the first helper key c, helper data c1 and verification key vk transmitted from the biometric-based key generation apparatus 110, respectively. It is of course possible for the first helper key acquisition part 121A, helper data acquisition part 123A, and verification key acquisition part 120A to receive the first helper key c, helper data c1, and verification key vk at separate times.
(2) The secret information acquisition part 122A receives the secret information s′₂ for second nonce generation transmitted from the secret information generation apparatus 150.
(3) The first helper key acquisition part 121A stores the first helper key c in the first helper key storage part 121B, the helper data acquisition part 123A stores the helper data c₁ in the helper data storage part 123B, and the verification key acquisition part 120A stores the verification key vk in the verification key storage part 120B. The secret information acquisition part 122A stores the secret information s′₂ in the secret information storage part 122B.

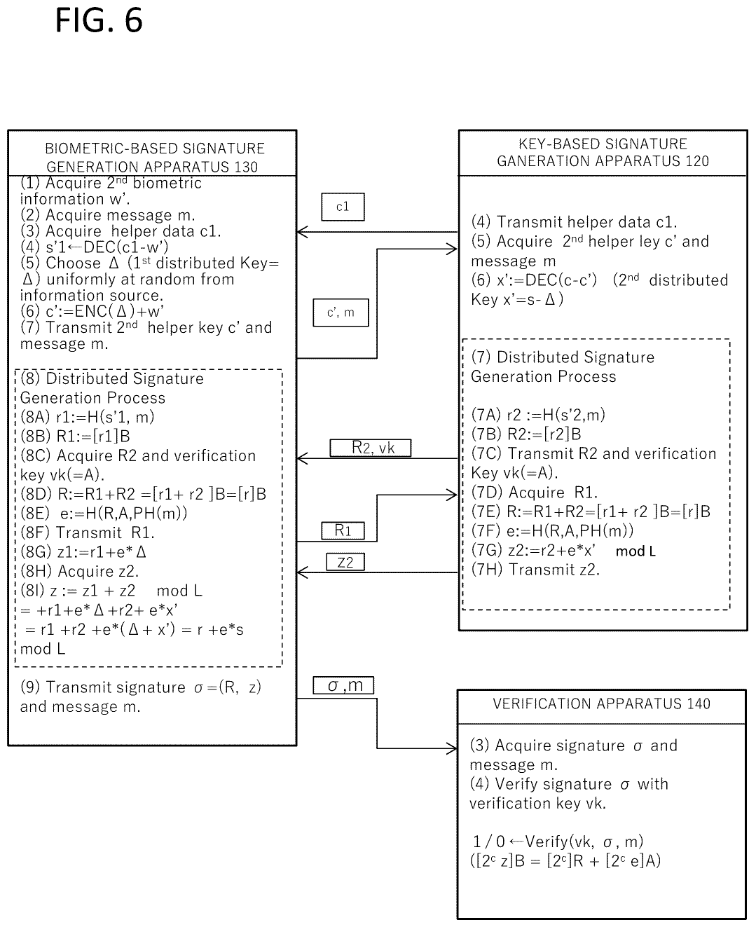

In the key-based signature generation apparatus 120 of FIG. 4, the first helper key storage part 121B, helper data storage part 123B, secret information storage part 122B, and verification key storage part 120B may be separate storage apparatuses (storage) or a single storage part. FIG. 6 illustrates the signature generation process and the verification process in the system 100 of FIG. 4.

When generating a signature, the biometric-based signature generation apparatus 130 may perform, for example, following steps.
(1) The second biometric information acquisition part 131 acquires the user's second biometric information w′. The second biometric information w′ and the first biometric information w is assumed to be of the same modality.
(2) The message acquisition part 134A acquires a message m (electronic document) to be signed.
(3) The helper data acquisition part 132 acquires helper data c₁ from the key-based signature generation apparatus 120. The helper data acquisition part 132 may transmit a request for acquiring helper data c₁ to the key-based signature generation apparatus 120 and receive the helper data c₁ from the key-based signature generation apparatus 120.
(4) The secret information restoration part 133 restores the secret information s′₁ for first nonce generation using the helper data c₁ and the second biometric information w′.

$${{s}^{′}}_{1} := DEC ( {c}_{1} - {w}^{′} ) \qquad ( 60 )$$

When the second biometric information w′ is close to the first biometric information w (i.e., a distance between w and w′ is within a correction range (capability), as described above), a result of the decoding operation.

$$DEC ( {c}_{1} - {w}^{′} ) \qquad ( 61 )$$

is s′₁.
(5) The first distributed key generation part 135 selects (generates) the first distributed key Δ uniformly at random from an information source.
(6) The distributed signature generation part 138 generates a second helper key c′ using the value ENC (Δ) encoded by the first distributed key Δ and the second biometric information w′.

$${c}^{′} := ENC ( Δ ) + {w}^{′} \qquad ( 62 )$$

(7) The second helper key and message transmission part 137 transmits the second helper key c′ and message m to the key-based signature generation apparatus 120. Although the second helper key and message transmission part 137 is shown as a single unit, it is of course possible to configure the second helper key transmission unit and the message transmission unit as separate units.
(8) The distributed signature generation part 138 exchanges information with the distributed signature generation part 126 of the key-based signature generation apparatus 120 to generate a signature.
(8A) The distributed signature generation part 138 inputs a value of the secret information s′₁ for first nonce generation concatenated with the message m into the hash function H to compute the first nonce (integer).

$${r}_{1} := H ( {{s}^{′}}_{1} , m ) \qquad ( 63 )$$

(8B) The distributed signature generation part 138 uses r₁ to find the first rational point R₁ on the elliptic curve (base point B is added to the first nonce r₁ times).

$${R}_{1} := [ {r}_{1} ] B \qquad ( 64 )$$

(8C) The distributed signature generation part 138 receives the second rational point R₂ on the elliptic curve transmitted from the distributed signature generation part 126 of the key-based signature generation apparatus 120. The distributed signature generation part 138 receives the verification key vk transmitted from the distributed signature generation part 126 of the key-based signature generation apparatus 120. It suffices that in the distributed signature generation part 138, acquisition of the verification key vk stored in the key-based signature generation apparatus 120 may be done before step (8E), which may as a matter of course be done separately from acquisition of the second rational point R2.
(8D) The distributed signature generation part 138 finds the third rational point R by addition of the first rational point R₁ on the elliptic curve and the second R₂ on the elliptic curve.

$$R := {R}_{1} + {R}_{2} = [ {r}_{1} + {r}_{2} ] B \qquad ( 65 )$$

(8E) The distributed signature generation part 138 concatenates the third rational point R, the verification key vk(=A), and PH(m) and inputs them into the hash function H to compute a hash value e.

$$e := H ( R , A , PH ( m ) ) \qquad ( 66 )$$

(8F) The distributed signature generation part 138 transmits the first rational point R₁ on the elliptic curve to the distributed signature generation part 126 of the key-based signature generation apparatus 120. The transmission of R₁ by the distributed signature generation part 138 may be performed at any timing in response to a request to obtain R₁ from the distributed signature generation part 126 of the key-based signature generation apparatus 120.
(8G) The distributed signature generation part 138 computes the first partial signature z₁.

$$\begin{matrix}{z}_{1} := {r}_{1} + e * Δ & mod L\end{matrix} \qquad ( 67 )$$

It is noted that since z₁ is an element z (=z₁+z₂) of the signature σ=(R,z) when combined (added) with z₂, z₁ may be called the first partial signature (first distributed signature) because
(8H) The distributed signature generation part 138 receives z₂ (=r₂+e*x′) from the distributed signature generation part 126 of the key-based signature generation apparatus 120. The distributed signature generation part 138 may obtain z₂ by making a request to the distributed signature generation part 126 of the key-based signature generation apparatus 120 to obtain z₂. It is noted that since z₂ is an element z (=z₁+z₂) of the signature σ=(R,z) when combined (added) with the first partial signature (first distributed signature) z₁, z₂ may be called a second partial signature (second distributed signature).
(8I) The distributed signature generation part 138 adds the second partial signature (second distributed signature) z₂ to the first partial signature (first distributed signature) z₁ to compute z of the signature σ=(R,z).

$$\begin{matrix}z := {r}_{1} + e * Δ + {r}_{2} + e * {x}^{′} = {r}_{1} + {r}_{2} + e * ( Δ + {x}^{′} ) \\ = {r}_{1} + {r}_{2} + e * ( Δ + ( s - Δ ) ) \\ = {r}_{1} + {r}_{2} + e * s mod L\end{matrix} \qquad ( 68 )$$

(9) The distributed signature generation part 138 transmits the signature σ=(R,z) and the message m to the verification apparatus 140.
   It is noted that the biometric-based signature generation apparatus 130 may delete (or reset or zero-clear the corresponding variable regions, etc.) the helper data c₁, the first secret information s′₁, the first distributed key Δ and the second helper key c′ after the distributed signature generation process (step (8)) is completed. The information on r₁, R₁, R₂, e, z₁, z₂, z generated or obtained in the distributed signature creation step (step (8)) may also be deleted (or relevant variable areas, storage areas, etc. may be reset or cleared to zero) after the signature σ=(R, z) is transmitted to the verification apparatus 140.

The key-based signature generation apparatus 120 may perform, for example, following steps, following the step (3) of the key-based signature generation apparatus 120 shown in FIG. 5.
(4) The helper data transmission part 123C transmits helper data c₁ to the biometric-based signature generation apparatus 130.
(5) The second helper key/message acquisition part 124 acquires the second helper key c′ and message m from the biometric-based signature generation apparatus 130.
(6) The second distributed key generation part 125 generates a second distributed key x′ using the first helper key c and the second helper key c′.

$${x}^{′} := DEC ( c - {c}^{′} ) \qquad ( 69 )$$

The right side of Equation (69) is

$$DEC ( c - {c}^{′} ) = DEC ( ENC ( s ) + w - ( ENC ( Δ ) + {w}^{′} ) ) = DEC ( ENC ( s - Δ ) ) + ( w - {w}^{′} ) ) . \qquad ( 70 )$$

When the first biometric information w is close to the second biometric information w′ (i.e., a difference (distance) between w and w′ is within a correction range), the Equation (70) becomes

$$DEC ( c - {c}^{′} ) = s - Δ \qquad ( 71 )$$

### That is,

$${x}^{′} = s - Δ \qquad ( 72 )$$

(7) The distributed signature generation part 126 exchanges information with the distributed signature generation part 138 of the biometric-based signature generation apparatus 130 to generate a partial signature for transmission to the distributed signature generation part 138.
(7A) The distributed signature generation part 126 computes the second nonce r₂ (integer), which is the hash value obtained by concatenating the secret information s′₂ for second nonce generation and the message m.

$${r}_{2} := H ( {{s}^{′}}_{2} , m ) \qquad ( 73 )$$

(7B) The distributed signature generation part 126 finds the second rational point R₂ on the elliptic curve (adding the base point B r₂ times).

$${R}_{2} := [ r 2 ] B \qquad ( 74 )$$

(7C) The distributed signature generation part 126 transmits R₂ to the distributed signature generation part 138 of the biometric-based signature generation apparatus 130. The distributed signature generation part 126 transmits the verification key vk to the distributed signature generation part 138 of the biometric-based signature generation apparatus 130. It is noted that in FIG. 6, the second rational point R₂ and the verification key vk are transmitted together, but the distributed signature generation part 126 may, of course, transmit the second rational point R₂ and the verification key vk separately.
(7D) The distributed signature generation part 126 acquires R₁ from the distributed signature generation part 138 of the biometric-based signature generation apparatus 130.
(7E) The distributed signature generation part 126 computes the third rational point R by adding the first rational point R₁ on the elliptic curve and the second rational point R₂ on the elliptic curve using addition on the elliptic curve.

$$R := {R}_{1} + {R}_{2} = [ {r}_{1} + {r}_{2} ] B \qquad ( 75 )$$

(7F) The distributed signature generation part 126 concatenates the third rational point R and the signature verification key vk (=A) with PH(m), then inputs them into the hash function H to compute a hash value e.

$$e := H ( R , A , PH ( m ) ) \qquad ( 76 )$$

(7G) The distributed signature generation part 126 computes

$${z}_{2} := {r}_{2} + e * {s}_{2} mod L \qquad ( 77 )$$

(7H) The distributed signature generation part 126 transmits z₂ to the distributed signature generation part 138 of the biometric-based signature generation apparatus 130.

It is noted that in the key-based signature generation apparatus 120, after the distributed signature generation process (step (7)) is completed, the second helper key c′ and the second distributed key x′ may be deleted (or the corresponding variable areas, memory areas, etc. may be reset or zero cleared). It is also noted that the information 12, R₁, R₂, e, and z₂ generated or obtained in the distributed signature generation process (step (7)) may be deleted (or the corresponding variable areas, memory areas, etc. may be reset or zero cleared).

The verification apparatus 140 may perform following steps.
(3) Receives the signature σ and the message m.
(4) Verify whether a set of the signature σ and the message m is correct using verification key vk.

$$[ {2}^{c} z ] B = [ {2}^{c} ] R + [ {2}^{c} e ] A \qquad ( 78 )$$

If the above equation holds, the signature is accepted (Verify (vk, σ, m) returns, for example, 1), else (if it does not hold), the signature is rejected (Verify(vk,σ,m) returns, for example, 0).

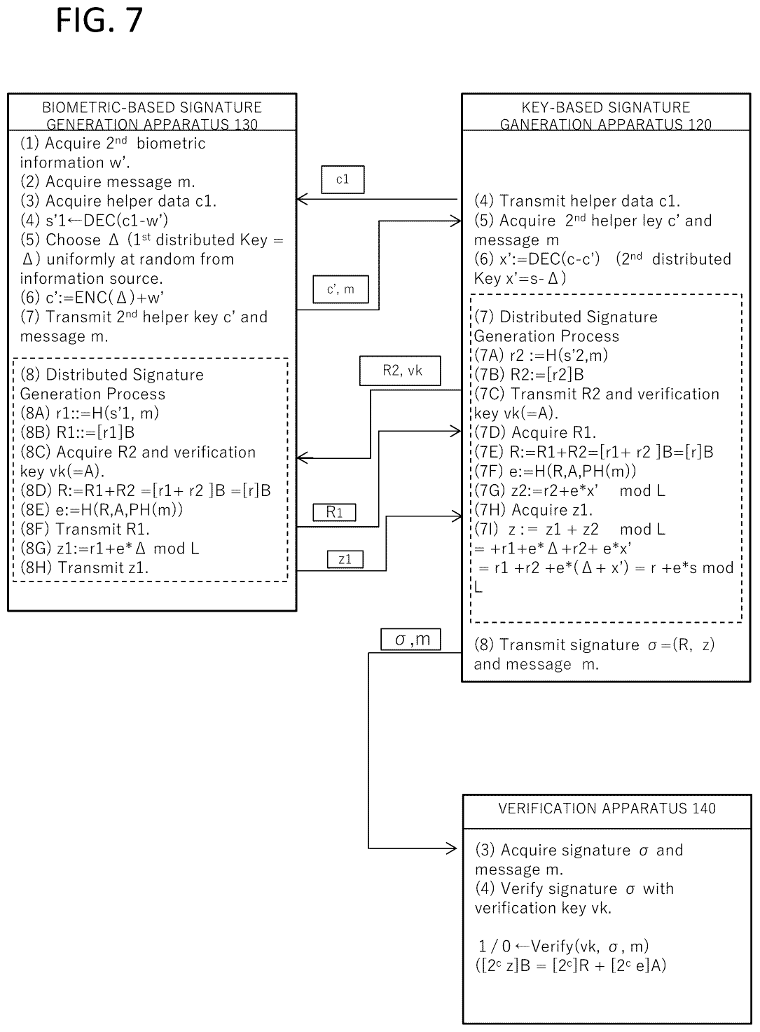

In FIG. 6, the steps (8G) to (8I) of the distributed signature generation process of the biometric-based signature generation apparatus 130 and the step (7H) of the distributed signature generation process of the key-based signature generation apparatus 120 are performed as shown in FIG. 7. In step (8H) of the distributed signature generation process of the biometric-based signature generation apparatus 130, z₁ is transmitted to the distributed signature generation process of the key-based signature generation apparatus 120. In step (7H) of the distributed signature generation process of the key-based signature generation apparatus 120, z₁ is received, and in step (7I), z=z₁+z₂ is computed. In step (8), the signature σ=(R,z) and the message m may be transmitted from the key-based signature generation apparatus 120 to the verification apparatus 140. In this case, instead of the signature/message transmission part 139 of the biometric-based signature generation apparatus 130 shown in FIG. 4, the key-based signature generation s 120 includes a signature/message transmission unit.

The following describes an example in which an encoding using a square lattice disclosed in for example Reference Literature 3 is applied as a non-limiting example of the encoding function ENC where the first biometric information w and the second biometric information w′ are n-dimensional vectors.

The first biometric information w and the second biometric information w′ are assumed to be n-dimensional real number vectors.

$$w = ( {w}_{1} , … , {w}_{n} ) , {w}^{′} = ( {w}_{1}^{′} , … , {w}_{n}^{′} ) \qquad ( 79 )$$

A distance between the first biometric information w and the second biometric information w′ may be expressed, for example, by the Chebyshev distance (also termed as L^{∞} distance or L^{∞} norm) as follows.

$${d}_{∞}^{( n )} ( w , {w}^{′} ) = max \{ \vert wi - {w}^{′} i \vert , i = 1 , … , n \} \qquad ( 80 )$$

If the distance d_{∞}⁽ⁿ⁾ (w, w′) is less than or equal to a predetermined threshold

$${t}_{h} ( {d}_{∞}^{( n )} ( w , {w}^{′} ) \leq {t}_{h} ) ,$$

the first biometric information w and the second biometric information w′ are considered to be identical (same biometric information).

A lattice point set L may be defined as follows.

L={Y=(y₁, . . . , yₙ)|yᵢ is a non-negative integer, 0≤yᵢ≤K} (81)

where K is a given positive integer that is sufficiently larger than tₕ and |wᵢ|.

A function int( ) that maps a single integer u to an n-dimensional integer vector Y∈L may be defined as below.

$$u ← int ( Y ) = {\sum }_{i = 1}^{n} y {i ( 2 K )}^{i - 1} \qquad ( 82 )$$

The inverse function int⁻¹( ) is a function that maps an integer u to an n-dimensional integer vector Y.

$$Y ← {int}^{- 1} ( u ) \qquad ( 83 )$$

When the first secret information s′₁ (a positive integer) is input to the inverse function int-1 ( ) an n-dimensional integer vector A is obtained.

$$A = ( {a}_{1} , … , {a}_{n} ) ← {int}^{- 1} ( {s}_{1}^{′} ) \qquad ( 84 )$$

The encoding function ENC may be defined as below.

$$ENC ( ) = 2 th * {int}^{- 1} ( ) \qquad ( 85 )$$

It is noted that as the encoding function ENC, the following holds.

$$ENC ( {m}_{1} ) + E N C ( {m}_{2} ) = ENC ( {m}_{1} + {m}_{2} ) .$$

The encoded value of s′₁ in step (6) of the biometric-based key generation apparatus 110 becomes an n-dimensional vector and is given as below.

$$ENC ( {s}_{1}^{′} ) = 2 th * {int}^{- 1} ( {s}_{1}^{′} ) = 2 th * ( {a}_{1} , … , {a}_{n} ) \qquad ( 86 )$$

Therefore, the helper data c₁ generated by the biometric-based key generation apparatus 110 in FIG. 5 is expressed as follows.

$${c}_{1} := ENC ( {s}_{1}^{′} ) + w = 2 th * ( {a}_{1} , … , {a}_{n} ) + ( {w}_{1} , … , {w}_{n} ) = ( 2 th * {a}_{1} + {w}_{1} , … , 2 th * {a}_{n} + {w}_{n} ) \qquad ( 87 )$$

As a non-limiting example where the square lattice is used for encoding and the encoding function ENC is 2tₕ*int⁻¹( ) the decoding function DEC may be given as

$$D E C ( x ) = int ( x / 2 {t}_{h} ) \qquad ( 88 )$$

Step (4) of the biometric-based signature generation apparatus 130 shown in FIG. 6, computes

$${s}_{1}^{′} ← DEC ( {c}_{1} - {w}^{′} ) \qquad ( 89 )$$

where an argument of the decoding function DEC is

$${c}_{1} - {w}^{′} = ( 2 {t}_{h} * {a}_{1} + {w}_{1} , … , 2 {t}_{h} * {a}_{n} + {w}_{n} ) - ( {w}_{1}^{′} , … , {w}_{n}^{′} ) = ( 2 {t}_{h} * {a}_{1} + {w}_{1} - {w}_{1}^{′} , … , 2 {t}_{h} * {a}_{n} + {w}_{n} - {w}_{n}^{′} ) \qquad ( 90 )$$

### Therefore,

$$DEC ( {c}_{1} - {w}^{′} ) = int \{ ( 1 / 2 {t}_{h} ) ( 2 {t}_{h} * {a}_{1} + {w}_{1} - {w}_{1}^{′} , … , 2 {t}_{h} * {a}_{n} + {w}_{n} - {w}_{n}^{′} ) \} = int \{ ( 1 / 2 {t}_{h} ) ( 2 {t}_{h} * {a}_{1} , … , 2 {t}_{h} * {a}_{n} ) \} + ( 1 / 2 {t}_{h} ) ( {w}_{1} - {w}_{1}^{′} , … , {w}_{n} - {w}_{n}^{′} ) \} = int \{ ( {a}_{1} , … , {a}_{n} ) + ( 1 / 2 {t}_{h} ) ( {w}_{1} - {w}_{1}^{′} , … , {w}_{n} - {w}_{n}^{′} ) \qquad ( 91 )$$

When the first biometric information w and the second biometric information w′ are such that

$${d}_{∞}^{( n )} ( w , {w}^{′} ) = max \{ \vert {W}_{i} - {W}_{i}^{′} \vert , i = 1 , … , n \} \leq {t}_{h} \qquad ( 92 )$$

each element of the n-dimensional vector (½tₕ) (w₁−w′₁, . . . , wₙ−W′ₙ) in Equation (91) is less than or equal to ±½ with an integer value thereof being 0, and the following holds.

$$DEC ( c 1 - {w}^{′} ) = int \{ ( {a}_{1} , … , {a}_{n} ) \} = {s}_{1}^{′} \qquad ( 93 )$$

In step (6) of the biometric-based key generation apparatus 110 shown in FIG. 5, the encoded value of the secret information s becomes an n-dimensional integer vector and is given as below.

$$ENC ( s ) = 2 {t}_{h} * {int}^{- 1} ( s ) = 2 {t}_{h} * ( {e}_{1} , … , {e}_{n} ) \qquad ( 94 )$$

Therefore, in the biometric-based key generation apparatus 110 shown in FIG. 5, the first helper key c generated in step (4) is given as below.

$$c := ENC ( s ) + w = 2 {t}_{h} * ( {e}_{1} , … , {e}_{n} ) + ( {w}_{1} , … , {w}_{n} ) = ( 2 {t}_{h} * {e}_{1} + {w}_{1} , … , 2 {t}_{h} * {e}_{n} + {w}_{n} ) \qquad ( 95 )$$

In the biometric-based signature generation apparatus 130, in step (6) of FIG. 6, the encoded value of the first distributed key Δ is given as below.

$$ENC ( Δ ) = 2 {t}_{h} * {int}^{- 1} ( Δ ) = 2 {t}_{h} * ( {f}_{1} , … , {f}_{n} ) \qquad ( 96 )$$

Therefore, in the biometric-based signature generation apparatus 130 of FIG. 6, the second helper key c′ in step (6) is expressed as follows.

$${c}^{′} := ENC ( Δ ) + {w}^{′} = 2 {t}_{h} * ( {f}_{1} , … , {f}_{n} ) + ( {w}_{1}^{′} , … , {w}_{n}^{′} ) = ( 2 {t}_{h} * {f}_{1} + {w}_{1}^{′} , … , 2 {t}_{h} * {f}_{n} + {w}_{n}^{′} ) \qquad ( 97 )$$

In the key-based signature generation apparatus 120 shown in FIG. 6, the input argument c−c′ of the decoding function DEC (c−c′) in step (6) is expressed as follows.

$$\begin{matrix}c - {c}^{′} = ( 2 {t}_{h} * {e}_{1} + {w}_{1} , … , 2 {t}_{h} * {e}_{n} + {w}_{n} ) - \\ ( 2 {t}_{h} * {f}_{1} + {w}_{1}^{′} , … , 2 {t}_{h} * {f}_{n} + {w}_{n}^{′} ) \\ = ( 2 {t}_{h} ) ( {e}_{1} - {f}_{1} , … , {e}_{n} - {f}_{n} ) + \\ ( {w}_{1} - {w}_{1}^{′} , … , {w}_{n} - {w}_{n}^{′} )\end{matrix} \qquad ( 98 )$$

$$Therefore ,$$

$$\begin{matrix}DEC ( c - {c}^{′} ) = int \{ ( 1 / 2 {t}_{h} ) ( 2 {t}_{h} ) ( {e}_{1} - {f}_{1} , … , {e}_{n} - {f}_{n} ) + \\ ( 1 / 2 {t}_{h} ) ( {w}_{1} - {w}_{1}^{′} , … , {w}_{n} - {w}_{n}^{′} ) \} \\ = int \{ ( {e}_{1} - {f}_{1} , … , {e}_{n} - {f}_{n} ) + \\ ( 1 / 2 {t}_{h} ) ( {w}_{1} - {w}_{1}^{′} , … , {w}_{n} - {w}_{n}^{′} ) \} \\ = int \{ ( {e}_{1} , … , {e}_{n} ) - ( {f}_{1} , … , {f}_{n} ) \} + \\ ( 1 / 2 {t}_{h} ) ( {w}_{1} - {w}_{1}^{′} , … , {w}_{n} - {w}_{n}^{′} ) \}\end{matrix} \qquad ( 99 )$$

$$Therefore , when$$

$${d}_{∞}^{( n )} ( w , {w}^{′} ) = max \{ \vert {w}_{i} - {w}_{i}^{′} \vert , i = 1 , … , n \} \leq {t}_{h} \qquad ( 100 )$$

then, since each element of the n-dimensional vector (½tₕ) (w₁−w′₁, . . . , wₙ−W′ₙ) in Equation (98) is less than or equal to ±½,

$$DEC ( c - {c}^{′} ) = int \{ ( {e}_{1} , … , {e}_{n} ) - ( {f}_{1} , … , {f}_{n} ) \} = s - Δ . \qquad ( 101 )$$

The message m may be provided externally to each of the key-based signature generation apparatus 120 and the biometric-based signature generation apparatus 130.

For the purpose of enhancing security, a zero-knowledge proof (non-interactive zero-knowledge: NIZK) may be performed from the biometric-based signature generation apparatus 130 to the key-based signature generation apparatus 120 to prove knowledge regarding the first nonce r₁. In this case, the biometric-based signature generation apparatus 130 and the key-based signature generation apparatus 120 share a proof generation key and a proof verification key. For example, in FIG. 6, the distributed signature generation part 138 of a prover, which is the biometric-based signature generation apparatus 130, may perform computation of the first rational point R₁ of the elliptic curve using the first nonce r₁ (step (8B) of the biometric-based signature generation apparatus 130 in FIG. 6), and then may generate a proof (NIZK proof) π1 from a specific example of a proposition to be proven (instance: knowing the first nonce r₁) and an evidence (witness) that the proposition is correct, and may transmit the instance (R₁) and the proof π1 to the key-based signature generation apparatus 120, which is a verifier. The verifier, key-based signature generation apparatus 120, may verify the proof π1 using the proof verification key after receiving the instance (R₁) and the proof π1.

A non-interactive zero-knowledge proof of knowing the second nonce r₂ may be performed from the key-based signature generation apparatus 120 to the biometric-based signature generation apparatus 130. For example, in FIG. 6, the distributed signature generation part 126 of the key-based signature generation apparatus 120, which is a prover, may perform computation of the second rational point R₂ of the elliptic curve using, for example, the second nonce r₂ (step (7C) of the key-based signature generation apparatus 120 in FIG. 6), and then may generate a proof 12 from the specific example of a proposition to be proven (instance: knowing the second nonce r₂) and an evidence that the proposition is correct, and then transmit the instance (R₂) and the proof π2 to the verifier, the biometric-based signature generation apparatus 130. The verifier, the biometric-based signature generation apparatus 130, may receive the instance (R₂) and the proof π2 and then verifies the proof π2 using the proof verification key. The biometric-based signature generation apparatus 130 may decommit the commitment to the instance (R₂) and the proof π2, and the key-based signature generation apparatus 120 may verify the proof π2 after the commitment has been decommitted (Reference Literature 4).

FIG. 8 is a diagram illustrating another example of the system of the present disclosure. The biometric-based key generation apparatus 110, the secret information generation apparatus 150, and the verification apparatus 140 are the same as those shown in FIG. 4.

The biometric-based signature generation apparatus 130 includes a second biometric information acquisition part 131, a helper data acquisition part 132, a secret information restoration part 133, a message acquisition part 134A, a message transmission part 134B, a second helper key acquisition part 137A, a first distributed key generation part 135, and a distributed signature generation part 138.

The key-based signature generation apparatus 120 includes a first helper key acquisition part 121A, a first helper key storage part 121B, a secret information acquisition part 122A, a secret information storage part 122B, a helper data acquisition part 123A, a helper data storage part 123B, a helper data transmission part 123C, a message acquisition part 128A, a second distributed key generation part 125, a second helper key generation part 129A, a second helper key transmission part 129B, a distributed signature generation part 126, a signature/message transmission part 127, a verification key acquisition part 120A, and a verification key storage part 120B.

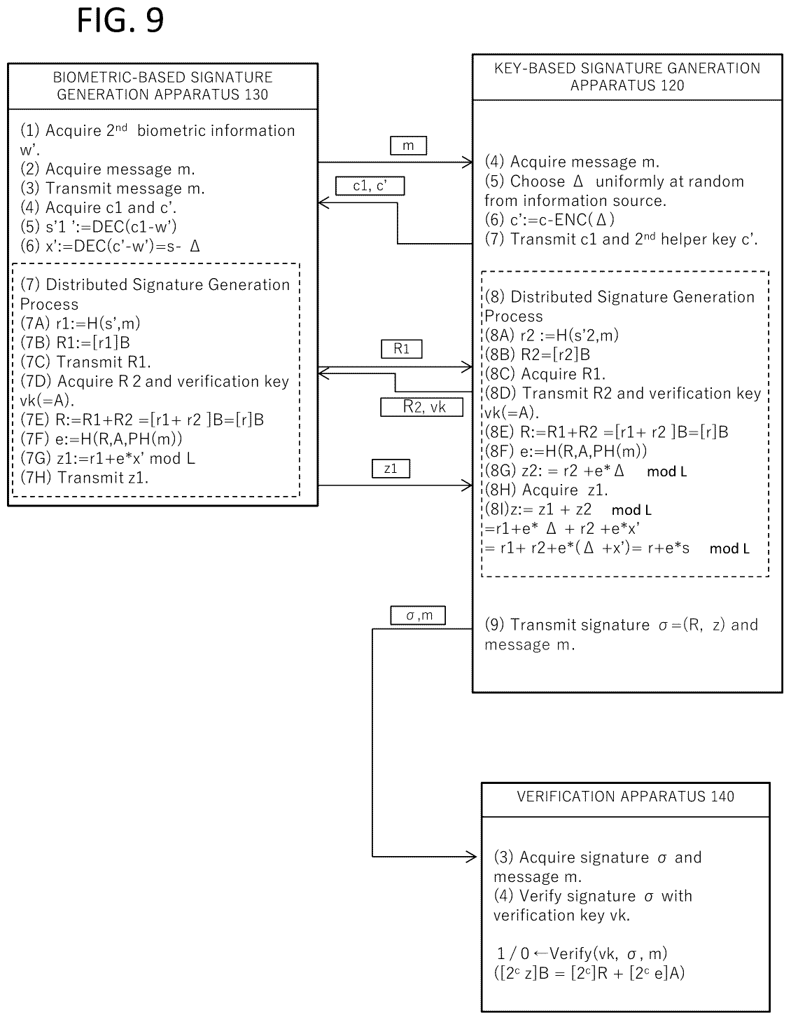

FIG. 9 is a diagram illustrating a process of each apparatus of the system 100 of FIG. 8. It is noted that the biometric-based key generation apparatus 110 and the secret information generation apparatus 150 are the same as in FIG. 5, so the descriptions thereof are omitted. The verification key acquisition part 120A of the key-based signature generation apparatus 120 acquires the verification key vk generated by the biometric-based key generation apparatus 110 and stores it in the verification key storage part 120B (processing steps 1 and 2 in FIG. 5).

In signing phase, the biometric-based signature generation apparatus 130 may perform following steps.
(1) The second biometric information acquisition part 131 acquires the user's second biometric information w′. The second biometric information w′ and the first biometric information w are of the same modality.
(2) The message acquisition part 134A acquires a message m (electronic document) to be signed.
(3) The message transmission part 134B transmits the message m to key-based signature generation apparatus 120.
(4) The helper data acquisition part 132 acquires the helper data c₁ transmitted from the key-based signature generation apparatus 120. The second helper key acquisition part 137A acquires the second helper key c′ transmitted from the key-based signature generation apparatus 120.
(5) The secret information restoration part 133 restores the secret information s′₁ for first nonce generation using the helper data c₁ and the second biometric information w′.

$${s}_{1}^{′} = DEC ( {c}_{1} - {w}^{′} ) \qquad ( 102 )$$

As described above, when the second biometric information w′ is close to the first biometric information w (such as both from the same person), a result of the decoding operation

$$DEC ( {c}_{1} - {w}^{′} ) \qquad ( 103 )$$

is s′₁.
(6) The first distributed key generation part 135 generates the first distributed key x′ by using

$${x}^{′} := DEC ( {c}^{′} - {w}^{′} ) \qquad ( 104 )$$

The right side of Equation (104), DEC(c′−w′), is

$$DEC ( {c}^{′} - {w}^{′} ) = DEC ( c - ENC ( Δ ) - {w}^{′} ) = DEC ( ENC ( s ) + w - ENC ( Δ ) - {w}^{′} ) = DEC ( ENC ( s - Δ ) + ( w - {w}^{′} ) ) \qquad ( 105 )$$

When the first biometric information w is close to the second biometric information w′ (such as both from the same person),

$$DEC ( {c}^{′} - {w}^{′} ) = s - Δ \qquad ( 106 )$$

$$∴ {x}^{′} = s - Δ \qquad ( 107 )$$

(7) The distributed signature generation part 138 exchanges information with the distributed signature generation part 126 of the key-based signature generation apparatus 120 to generate a signature.
(7A) The distributed signature generation part 138 concatenates the secret information s′₁ for first nonce generation and the message m (plaintext to be signed), inputs them into the hash function H, and computes the first nonce (integer), which is a hash value of s′₁ and m.

$${r}_{1} := H ( {s}_{1}^{′} , m ) \qquad ( 108 )$$

(7B) The distributed signature generation part 138 uses r₁ to find the first rational point R₁ on the elliptic curve.

$${r}_{1} := [ {r}_{1} ] B \qquad ( 109 )$$

(7C) The distributed signature generation part 138 transmits R₁ to the distributed signature generation part 126 of the key-based signature generation apparatus 120. It is noted that the transmission of R₁ by the distributed signature generation part 138 may be performed at any timing in response to a request for R₁ from the distributed signature generation part 126 of the key-based signature generation apparatus 120.
(7D) The distributed signature generation part 138 receives the second rational point R₂ on the elliptic curve transmitted from the key-based signature generation apparatus 120. The distributed signature generation part 138 acquires the verification key vk from the key-based signature generation apparatus 120. The acquisition of the verification key vk may be performed before executing step (7F) and may be separate from that of the second rational point R₂.
(7E) The distributed signature generation part 138 adds the rational points R₁ and R₂ on the elliptic curve to obtain a rational point R on the elliptic curve.

$$R := {R}_{1} + {R}_{2} = [ {r}_{1} + {r}_{2} ] B \qquad ( 110 )$$

(7F) The distributed signature generation part 138 concatenates the rational point R and the verification key vk (=A) with PH(m), then inputs them into the hash function H to compute a hash value e.

$$e := H ( R , A , PH ( m ) ) \qquad ( 111 )$$

(7G) The distributed signature generation part 138 computes the first distributed signature (first partial signature) z₁.

$${z}_{1} := {r}_{1} + e * {x}^{′} mod L \qquad ( 112 )$$

(7H) The distributed signature generation part 138 transmits z₁ to the distributed signature generation part 126 of the key-based signature generation apparatus 120.

In the biometric-based signature generation apparatus 130, after the distributed signature generation process (step (7)) is completed, the helper data c₁, the second helper key c′, the first secret information s′₁, and the first distributed key x′ may be deleted (or the corresponding variable areas, memory areas, etc. may be reset or zero cleared). In addition, the information r₁, R₁, R₂, e, and z₁ generated or acquired in the distributed signature generation process (step (7)) may be deleted (or the corresponding variable areas, memory areas, etc. may be reset or zero cleared) after the distributed signature generation process (step (7)) is completed.

The key-based signature generation apparatus 120 may perform following steps after the step (3) in FIG. 5 in signature generation.
(4) Acquire the message m from the biometric-based signature generation apparatus 130.
(5) Generate (Choose) the second distributed key Δ uniformly at random from the information source.
(6) Obtain the second helper key c′ by combining an encoded value ENC(Δ) of the first helper key c and the second distributed key Δ.

$${c}^{′} := c - ENC ( Δ ) \qquad ( 113 )$$

(7) Transmit the second helper key c′ and helper data c₁ to the distributed signature generation part 138 of the biometric-based signature generation apparatus 130.
(8) The distributed signature generation part 126 exchanges information with the distributed signature generation part 138 of the biometric-based signature generation apparatus 130 to generate a distributed signature.
(8A) The distributed signature generation part 126 inputs the secret information s′₂ for second nonce generation and the message m into the hash function H, and computes the second nonce r₂ (an integer), which is a hash value of s′₂ and m.

$${r}_{2} := H ( {s}_{2}^{′} , m ) \qquad ( 114 )$$

(8B) The distributed signature generation part 126 computes a second rational point R₂ on the elliptic curve (by adding the base point B 12 times).

$${R}_{2} := [ {r}_{2} ] B \qquad ( 115 )$$

(8C) The distributed signature generation part 126 obtains the first rational point R₁ on the elliptic curve from the distributed signature generation part 138 of the biometric-based signature generation apparatus 130.
(8D) The distributed signature generation part 126 transmits the second rational point R₂ to the distributed signature generation part 138 of the biometric-based signature generation apparatus 130. The distributed signature generation part 126 transmits the verification key vk (=A) to the distributed signature generation part 138 of the biometric-based signature generation apparatus 130. It is noted that in FIG. 9, the second rational point R₂ and the verification key vk are transmitted together, but the distributed signature generation part 126 may transmit the second rational point R₂ and the verification key vk separately.
(8E) The distributed signature generation part 126 computes a third rational point R by adding the first rational point R₁ and the second rational point R₂ on the elliptic curve using an addition operation on the elliptic curve.

$$R := {R}_{1} + {R}_{2} = [ {r}_{1} + {r}_{2} ] B \qquad ( 116 )$$

(8F) The distributed signature generation part 126 concatenates the third rational point R, the verification key vk (=A), and PH(m), then inputs them into the hash function H to obtain e.

$$e := H ( R , A , PH ( m ) ) \qquad ( 117 )$$

(8G) The distributed signature generation part 126 computes the second distributed signature (second partial signature) z₂.

$${z}_{2} = {r}_{2} + e * Δ mod L \qquad ( 118 )$$

is computed.
(8H) The distributed signature generation part 126 receives z₁ from the distributed signature generation part 138 of the biometric-based signature generation apparatus 130.
(8I) The distributed signature generation part 126 adds z₁ to z₂ to obtain z (z of the signature σ=(R, z)).

$$z := {r}_{2} + e * Δ + {r}_{1} + e * {x}^{′} = {r}_{1} + {r}_{2} + e * ( Δ + {x}^{′} ) = {r}_{1} + {r}_{2} + e * ( Δ + ( s - Δ ) ) = {r}_{1} + {r}_{2} + e * s mod L \qquad ( 119 )$$

The distributed signature generation part 126 outputs the signature σ=(R, z) to the signature and message transmission part 127.
(9) The signature and message transmission part 127 transmits the signature σ=(R, z) and the message m to the verification apparatus 140.

In the key-based signature generation apparatus 120, after the distributed signature generation process (step (8)) is completed, the second distributed key Δ and the second helper key c′ may be deleted (or the corresponding variable area, memory area, etc. may be reset or zero cleared). Furthermore, the information 12, R₁, R₂, e, z₁, z₂, and z generated or obtained in the distributed signature generation process (step (8)) may be deleted (or the corresponding variable areas, memory areas, etc. may be reset or zero cleared) after the signature σ=(R,z) and message m are sent to the verification apparatus 140.

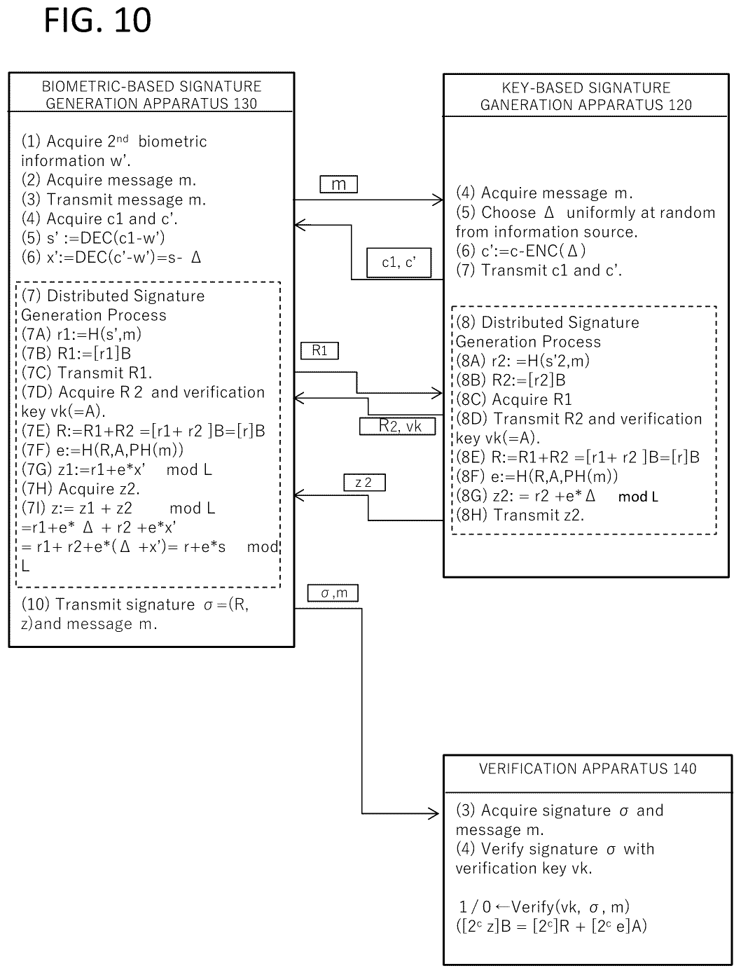

FIG. 10 is a variation example of FIG. 9, in which the generation of the signature σ=(R, z) is performed on the biometric-based signature generation apparatus 130, and the signature σ and the message m are transmitted from the biometric-based signature generation apparatus 130 to the verification apparatus 140. In the example of FIG. 10, the signature/message transmission part 127 of the key-based signature generation apparatus 120 in FIG. 8 is not required, and instead, a signature/message transmission part 139 (FIG. 4) is provided in the biometric-based signature generation apparatus 130. In FIG. 10, the distributed signature generation process: steps (7A) to (7G) of the biometric-based signature generation apparatus 130 are the same as the distributed signature generation process: steps (7A) to (7G) of the biometric-based signature generation apparatus 130 in FIG. 9. In step (7H) of the distributed signature generation process, z₂ is received from the key-based signature generation apparatus 120, and in step (7I), the distributed signature generation part 138 of the biometric-based signature generation apparatus 130 adds z₂ to z₁ to obtain z.

$$z := {r}_{1} + e * {x}^{′} + {r}_{2} + e * Δ = {r}_{1} + {r}_{2} + e * ( Δ + {x}^{′} ) = {r}_{1} + {r}_{2} + e * ( Δ + ( s - Δ ) ) = {r}_{1} + {r}_{2} + e * s mod L \qquad ( 120 )$$

(10) The signature/message transmission unit (139 in FIG. 4) of the biometric-based signature generation apparatus 130 transmits the signature σ=(R, z) and the message m to the verification apparatus 140.

The biometric-based signature generation apparatus 130 and the key-based signature generation apparatus 120 may each obtain the message m individually.

The biometric-based signature generation apparatus 130 transmits the hash value PH(m)=H′(m) of the message m (used in the calculation of e=H(R, A, PH(m)) in step (7F)) to the key-based signature generation apparatus 120, and the key-based signature generation apparatus 120 may use it in computation of the hash value (e=H(R, A, PH(m))) in step (8F).

The biometric-based key generation apparatus 110 may temporarily transmit the first helper key c and helper data c₁ to an apparatus other than the key-based signature generation apparatus 120, store them in the other apparatus, and have the key-based signature generation apparatus 120 request them from the other apparatus each time a signature is generated.

The secret information generation apparatus 150 may transmit the secret information to an apparatus other than the key-based signature generation apparatus 120, store it in the other apparatus, and obtain it each time a signature is generated by the key-based signature generation apparatus 120 making a retrieval request to the other apparatus.

The verification apparatus 140 may transmit the verification result to the biometric-based signature generation apparatus 130 which is a transmission source of the signature.

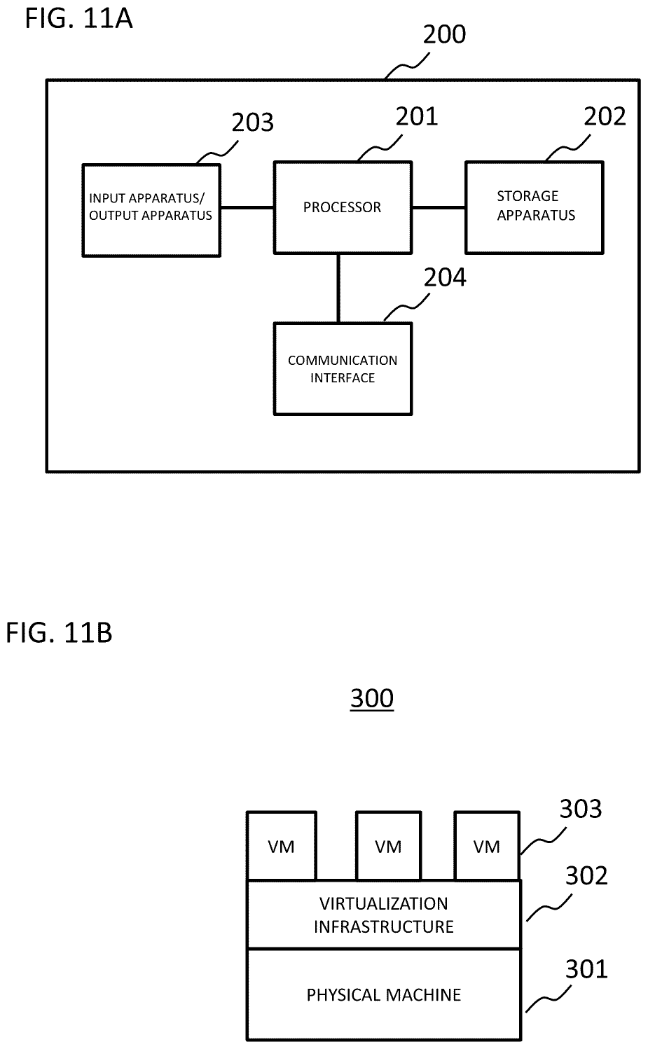

FIG. 11A and FIG. 11B are schematic diagrams each illustrating an example of implementing the above-described digital signature system 100 using computers equipped with communication functions and capable of communicating with each other via a network. Referring to FIG. 11A, each apparatus (110, 120, 130, 140, 150) of the system 100 includes a processor 201 (multiple processors are also possible), a storage apparatus 202, an input/output apparatus 203, and a communication interface 204. The storage apparatus 202 may be configured with semiconductor storage such as RAM (Random Access Memory), ROM (Read Only Memory), or EEPROM (Electrically Erasable and Programmable ROM), as well as HDD (Hard Disk Drive), CD (Compact Disc), or DVD (Digital Versatile Disc). The processor 201 executes a program (not shown) stored in the storage apparatus 202 to implement the processing and functions of each apparatus. The input/output apparatus 203 may also be configured with a keyboard and display. For example, in the key-based signature generation apparatus 120, the verification result (accepted or rejected) from the verification apparatus 140 may be displayed on an output apparatus such as a display. In addition, in the biometric-based key generation apparatus 110 and the biometric-based signature generation apparatus 130 that acquire biometric information, the input/output apparatus 203 may also be configured to include a sensor for acquiring biometric information. In this case, the sensor may be an image sensor (camera) when the biometric information is a face, iris, etc., a fingerprint sensor when the biometric information is a fingerprint, or, for example, an LED (Light Emitting Diode) that emits near-infrared light and a near-infrared camera that captures the light transmitted through the finger when the biometric information is a finger/palm vein. It is noted that the sensor may also be a removable sensor, such as a USB (Universal Serial Bus) apparatus. The communication interface 204 may be configured to communicate with each other via a LAN (Local Area Network), WAN (Wide Area Network) such as the Internet, wireless LAN, mobile communication network, etc., using a network interface card, transceiver, etc. The communication interface 204 may be configured to communicate with external sensors (e.g., Bluetooth-connected sensors) in the biometric-based key generation apparatus 110 and the biometric-based signature generation apparatus 130, and to receive biometric information acquired by the external sensors. The apparatuses 110, 130, and 150 of the system 100 may be client apparatuses (terminals), and apparatus 120 may be a server apparatus such as a cloud server.

FIG. 11B is a schematic diagram illustrating an example in which one or more of the apparatuses (110, 120, 130, 140, 150) of the digital signature system 100 described above are implemented as virtual machines of a virtualization system 300 using server virtualization technology. Multiple virtual machines (Virtual Machine: VM) 303 operate on a virtualization infrastructure 302, such as a hypervisor, implemented on a physical machine 301, such as a server apparatus. One or more of the apparatuses (110, 120, 130, 140, 150) of the digital signature system 100 may be implemented as virtual machines (VM) 303. With a single physical server, a virtualized server environment where multiple servers are running is provided. Each virtual machine (VM) 303 is preferably configured to operate in an isolated environment within memory space. In this case, within the virtual machine VM, a program that implements the processing of any of the apparatuses (110, 120, 130, 140, 150) runs on the virtual machine's virtual operating system (OS). The virtual machine VM, which virtually implements any of the apparatuses (110, 120, 130, 140, 150) may be configured to communicate with other virtual machines via a virtual network, or may be configured to communicate with other apparatuses (110, 120, 130, 140, 150) via a LAN, Internet, or other WAN through the physical interface (communication interface) of the physical machine 301.

The first biometric information w and the second biometric information w′ may be binary vectors, real number vectors, or integer vectors.
[Reference 1] CRYPTREC EX-3002-2020, Eiichiro Fujisaki, “Investigation and Evaluation of the Security of the EdDSA Digital Signature Scheme,” December 2020, [Accessed Jun. 10, 2024] Internet <URL: https://www.cryptrec.go.jp/exreport/cryptrec-ex-3002-2020.pdf>
[Reference 2] Q. Feng, D. He, M. Luo, Z. Li, and K.-K. R. Choo, “Practical Secure Two-Party EdDSA Signature Generation with Key Protection and Applications in Cryptocurrency,” 2020 IEEE 19th International Conference on Trust, Security and Privacy in Computing and Communications (TrustCom), 2020, pp. 137-147, 2020
[Reference 3] JP Patent No. 5707311
[Reference 4] Lindell, Yehuda. “Fast secure two-party ECDSA signing.” Advances in Cryptology-CRYPTO 2017: 37th Annual International Cryptology Conference, Santa Barbara, CA, USA, Aug. 20-24, 2017, Proceedings, Part II 37. Springer International Publishing, 2017

The above-described embodiments/examples may be supplemented as following notes, though not limited thereto.
(Note 1) A digital signature system comprises a first signature generation apparatus and a second signature generation apparatus, each of which includes at least a processor and a communication interface.
   The first signature generation apparatus is configured to:
acquire and store in a storage:
   a first helper key generated using first secret information corresponding to a verification key and first biometric information;
   helper data generated using second secret information for distributed signature generation and the first biometric information; and
   third secret information for distributed signature generation;
generate a second distributed key; and
generate a second distributed signature for a message to be signed, by using the second distributed key and the third secret information and sending/receiving information with the second signature generation apparatus.
   The second signature generation apparatus is configured to:
acquire second biometric information;
acquire the helper data;
restore the second secret information using the second biometric information and the helper data;
generate a first distributed key; and
by using the first distributed key and the second secret information, and sending/receiving information with the first signature generation apparatus,
generate the first distributed signature for the message.
   One of the first signature generation apparatus and the second signature generation apparatus is configured to generate a signature for the message using:
one (a first one) of the first distributed signature or the second distributed signature generated by the one of the first signature generation apparatus or the second signature generation apparatus; and
other (a second one) of the first distributed signature or the second distributed signature generated by other of the first signature generation apparatus or the second signature generation apparatus.
(Note 2) In the digital signature system according to Note 1, the second signature generation apparatus is configured to:
   generate a second helper key using the first distributed key and the second biometric information; and
   transmit the second helper key to the first signature generation apparatus.

The first signature generation apparatus is configured to:
receive the second helper key; and
generate the second distributed key using the first helper key and the second helper key.
(Note 3) In the digital signature system according to Note 1, the first signature generation apparatus is configured to:
   generate a second helper key using the helper data and the second distributed key; and
   transmit the second helper key to the second signature generation apparatus.

The second signature generation apparatus is configured to:
receive the second helper key; and
generate the first distributed key using the second helper key and the second biometric information.
(Note 4) In any of the digital signature systems according to Notes 1 to 3, including a key generation apparatus and a secret information generation apparatus, each including at least a processor and a communication interface.
   The key generation apparatus is configured to:
acquire the first biometric information;
generate the first secret information corresponding to a secret key;
generate the verification key from the first secret information and a base point of an elliptic curve;
generate the first helper key using the first secret information and the first biometric information;
generate the second secret information;
generates the helper data using the second secret information and the first biometric information; and
transmit the first helper key and the helper data to the first signature generation apparatus.

The secret information generation apparatus is configured to:
generate the third secret information;
transmit the third secret information to the first signature generation apparatus.

The first signature generation apparatus is configured to:
receive the first helper key and helper data transmitted from the key generation apparatus and store the first helper key and helper data in a first storage part and a second storage part, respectively; and
receive the third secret information transmitted from the secret information generation apparatus and store the third secret information in a third storage part.
(Note 5) In any of the digital signature systems according to Notes 1 to 3, the second signature generation apparatus is configured to:
   compute a first hash value related to the second secret information and the message;
   compute a first point of an elliptic curve from the first hash value and a base point of the elliptic curve;
   transmit the first point of the elliptic curve to the first signature generation apparatus;
   compute a second hash value of a third point obtained by adding on the elliptic curve the first point of the elliptic curve and a second point of the elliptic curve received from the first signature generation apparatus, the verification key, and the message;
   compute a first value as the first distributed signature, which is a sum of the first hash value and a value obtained by multiplying the second hash value by the first distributed key.

The first signature generation apparatus is configured to:
compute a third hash value regarding the third secret information and the message;
compute a second point on the elliptic curve from the base point of the elliptic curve using the third hash value;
transmit the second point on the elliptic curve to the second signature generation apparatus;
compute a fourth hash value of a third point obtained by adding the first point on the elliptic curve received from the second signature generation apparatus and the second point on the elliptic curve on the elliptic curve, the verification key, and the message; and
compute a second value, which is a sum of the third hash value and the value obtained by multiplying the fourth hash value by the second distribution key, as the second distributed signature.

The first signature generation apparatus or the second signature generation apparatus is configured to:
compute a third value by adding the second value to the first value; and
set a set of the third point on the elliptic curve and the third value as the signature for the message.
(Note 6) In the digital signature system of Note 5, each of the operations for obtaining the first value, the second value, and the third value is performed using a modular arithmetic with an order of a base point of the elliptic curve as a modulus.
(Note 7) In any of the digital signature systems according to Notes 1 to 6, there is provided a verification apparatus to verify the signature for the message using the verification key, and the first signature generation apparatus or the second signature generation apparatus transmits the signature and the message to the verification apparatus.
(Note 8) A digital signature method includes:
by a first apparatus:
   acquiring and storing: a first helper key generated using first secret information corresponding to a verification key and first biometric information; helper data generated using second secret information for distributed signature generation and the first biometric information; and third secret information for distributed signature generation;
   generating a second distributed key; and
   generating a second distributed signature for the message to be signed by using the second distributed key and the third secret information, and sending/receiving information with a second apparatus.
      The method includes:
by the second apparatus:
   acquiring the second biometric information;
   acquiring the helper data;
   restoring the second secret information using the second biometric information and the helper data;
   generating a first distributed key; and
   generating a first distributed signature for the message, by using the first distributed key and the second secret information and sending/receiving information with the first apparatus.
      The method includes, by one of the first apparatus or the second apparatus, generating a signature for the message using:
one (a first one) of the first distributed signature or the second distributed signature generated by the one of the first apparatus or the second apparatus; and
other (a second one) of the first distributed signature or the second distributed signature generated by other of the first apparatus or the second apparatus.
(Note 9) The digital signature method of Note 8, includes:
by the second apparatus:
   generating a second helper key using the first distributed key and the second biometric information; and
   transmitting the second helper key to the first apparatus.
      The method includes:
by the first apparatus:
   receiving the second helper key; and
   generating the second distributed key using the first helper key and the second helper key.
(Note 10) The digital signature method of Note 8, includes:
by the first apparatus:
   generating a second helper key using the helper data and the second distributed key; and
   transmitting the second helper key to the second apparatus, and by the second apparatus,
   receiving the second helper key; and
   generating the first distributed key using the second helper key and the second biometric information.
(Note 11) In any of the digital signature methods according to Notes 8 to 10, includes:
by a third apparatus:
   acquiring the first biometric information;
   generating the first secret information corresponding to a secret key;
   generating the verification key from the first secret information and the base point of the elliptic curve;
   generating the first helper key using the first secret information and the first biometric information;
   generating the second secret information;
   generating the helper data using the second secret information and the first biometric information; and
   transmitting the first helper key and the helper data to the first apparatus.
      The method includes:
by a fourth apparatus:
   generating the third secret information; and
   transmitting the third secret information to the first apparatus.
      The method includes:
by the first apparatus:
   receiving and storing in the first storage part and second storage part, the first helper key and helper data transmitted from the third apparatus, respectively;
   receiving and storing in a third storage part the third secret information transmitted from the fourth apparatus.
(Note 12) The digital signature methods according to Notes 8 to 11, includes:
by the second apparatus:
   computing a first hash value related to the second secret information and the message;
   computing a first point of the elliptic curve from the first hash value and a base point of the elliptic curve;
   transmitting the first point of the elliptic curve to the first apparatus;
   computing a second hash value of a third point obtained by adding on the elliptic curve the first point of the elliptic curve and a second point of the elliptic curve received from the first apparatus, the verification key, and the message;
   computing a first value as the first distributed signature, which is a sum of the first hash value and a value obtained by multiplying the second hash value by the first distributed key.
      The method includes:
by the first apparatus:
   computing a third hash value regarding the third secret information and the message;
   computing a second point on the elliptic curve from the base point of the elliptic curve using the third hash value;
   transmitting the second point on the elliptic curve to the second apparatus;
   computing a fourth hash value of a third point obtained by adding the first point on the elliptic curve received from the second signature generation apparatus and the second point on the elliptic curve on the elliptic curve, the verification key, and the message;
   computing the second value, which is a sum of the third hash value and the value obtained by multiplying the fourth hash value by the second distribution key, as the second distributed signature.
      The method includes:
by the first apparatus or the second apparatus:
   computing a third value by adding the second value to the first value; and
   setting a set of the third point on the elliptic curve and the third value as the signature for the message.
(Note 13) In the digital signature method of Note 12, each operation for acquiring the first value, the second value, and the third value is performed using modular arithmetic with an order of a base point of an elliptic curve as a modulus.
(Note 14) The digital signature methods of any one of Notes 8 to 13, includes, by the first apparatus or the second apparatus,
   transmitting the signature and the message to a verification apparatus that verifies the signature using the verification key.
(Note 15) A non-transitory storage medium storing a program causing a first processing apparatus to execute processing including:
   acquiring and storing in a storage:
      a first helper key generated using first secret information corresponding to a verification key and first biometric information;
      helper data generated using second secret information for distributed signature generation and the first biometric information; and
      third secret information for distributed signature generation;
   generating a second distributed key; and
   generating a second distributed signature for the message to be signed by using the second distributed key and the third secret information, and sending/receiving information with a second processing apparatus.
      The non-transitory storage medium stores a program causing a second processing apparatus to execute processing including:
acquiring second biometric information;
acquiring helper data generated using second secret information and first biometric information;
restoring the second secret information using the second biometric information and the helper data;
generating the first distributed key; and
generating the first distributed signature for the message by using the first distributed key and the second secret information and sending/receiving information with the first processing apparatus.
   The non-transitory storage medium stores the program causing one of the first processing apparatus or the second processing apparatus to execute processing including
generating a signature for the message using:
one (first one) of the first distributed signature or the second distributed signature generated by the one of the first processing apparatus or the second processing apparatus; and
other (second one) of the first distributed signature or the second distributed signature generated by other of the first processing apparatus and the second processing apparatus.
(Note 16) The storage medium of Note 15 stores the program that causes the second processing apparatus to perform processing including
   generating a second helper key using the first distributed key and the second biometric information; and
   transmitting the second helper key to the first processing apparatus.
      The non-transitory storage medium of Note 15 stores the program causing the first processing apparatus to perform processing including:
receiving the second helper key; and
generating the second distributed key using the first helper key and the second helper key.
(Note 17) The non-transitory storage medium of Note 15, stores the program causing the first processing apparatus to execute processing including:
   generating the second helper key using the helper data and the second distributed key; and
   transmitting the second helper key to the second processing apparatus,
   wherein the non-transitory storage medium stores the program causing the second processing apparatus to execute processing including
   receiving the second helper key; and
   generating the first distributed key using the second helper key and the second biometric information.

The disclosures of the above non-patent literature and references are incorporated herein by reference. Within the scope of the disclosure of the present application (including the claims), various modifications, adjustments, and combinations are possible based on the basic technical concept. Furthermore, within the scope of the claims of the present invention, various combinations or selections of disclosure elements (including each element of each Note, each element of each embodiment, each element of each figure, etc.) are possible. That is, the present disclosure naturally includes all disclosures, including the claims, as well as various modifications and revisions that would be obvious to those skilled in the art based on the technical concept.

What is claimed is:

1. A digital signature system comprising:
a first signature generation apparatus and a second signature generation apparatus, each including at least a processor; a memory storing a program executable by the processor; and a communication interface, and each communicatively connectable to each other,
wherein the processor included in the first signature generation apparatus is configured to:
acquire and store in a storage:
a first helper key generated using first secret information corresponding to a verification key and first biometric information;
helper data generated using second secret information for distributed signature generation and the first biometric information; and
third secret information for distributed signature generation;
generate a second distributed key; and
generate a second distributed signature for a message to be signed, by using the second distributed key and the third secret information and sending/receiving information with the second signature generation apparatus,
wherein the processor included in the second signature generation apparatus is configured to:
acquire second biometric information;
acquire the helper data,
restore the second secret information using the second biometric information and the helper data;
generate a first distributed key; and
generate the first distributed signature for the message, by using the first distributed key and the second secret information and sending/receiving information with the first signature generation apparatus,
wherein the processor included in one of the first signature generation apparatus or the second signature generation apparatus is configured to
generate a signature for the message using:
one of the first distributed signature or the second distributed signature generated by the one of the first signature generation apparatus or the second signature generation apparatus; and
other of the first distributed signature or the second distributed signature generated by other of the first signature generation apparatus or the second signature generation apparatus.

2. The digital signature system according to claim 1, wherein the processor included in the second signature generation apparatus is configured to
generate a second helper key using the first distributed key and the second biometric information to transmit the second helper key to the first signature generation apparatus,
wherein the processor included in the first signature generation apparatus is configured to:
receive the second helper key; and
generate the second distributed key using the first helper key and the second helper key.

3. The digital signature system according to claim 1, wherein the processor included in the first signature generation apparatus is configured to
generate a second helper key using the helper data and the second distributed key to transmit the second helper key to the second signature generation apparatus,
wherein the processor included in the second signature generation apparatus is configured to:
receive the second helper key; and
generate the first distributed key using the second helper key and the second biometric information.

4. The digital signature system according to claim 1, further comprising:
a key generation apparatus and a secret information generation apparatus, each including at least a processor and a communication interface,
wherein the processor included in the key generation apparatus is configured to:
acquire the first biometric information;
generate the first secret information corresponding to a secret key;
generate the verification key from the first secret information and a base point of an elliptic curve;
generate the first helper key using the first secret information and the first biometric information;
generate the second secret information;
generates the helper data using the second secret information and the first biometric information; and
transmit the first helper key and the helper data to the first signature generation apparatus,
wherein the processor included in the secret information generation apparatus is configured to:
generate the third secret information;
transmit the third secret information to the first signature generation apparatus,
wherein the processor included in the first signature generation apparatus is configured to:
receive and store in a first storage part and a second storage part, the first helper key and helper data transmitted from the key generation apparatus, respectively; and
receive and store in a third storage part, the third secret information transmitted from the information generation apparatus.

5. The digital signature system according to claim 1, wherein the processor included in the second signature generation apparatus is configured to:
compute a first hash value related to the second secret information and the message;
compute a first point of an elliptic curve from the first hash value and a base point of the elliptic curve;
transmit the first point of the elliptic curve to the first signature generation apparatus;
compute a second hash value of a third point obtained by adding on the elliptic curve the first point of the elliptic curve and a second point of the elliptic curve received from the first signature generation apparatus, the verification key, and the message;
compute a first value as the first distributed signature, which is a sum of the first hash value and a value obtained by multiplying the second hash value by the first distributed key,
wherein the processor included in the first signature generation apparatus is configured to:
compute a third hash value regarding the third secret information and the message;
compute a second point on the elliptic curve from the base point of the elliptic curve using the third hash value;
transmit the second point on the elliptic curve to the second signature generation apparatus;
compute a fourth hash value of a third point obtained by adding the first point on the elliptic curve received from the second signature generation apparatus and the second point on the elliptic curve on the elliptic curve, the verification key, and the message; and
compute a second value, which is a sum of the third hash value and the value obtained by multiplying the fourth hash value by the second distribution key, as the second distributed signature, and
wherein the processor included in the first signature generation apparatus or the second signature generation apparatus is configured to:
compute a third value by adding the second value to the first value; and
set a set of the third point on the elliptic curve and the third value as the signature for the message.

6. The digital signature system according to claim 5, wherein each of operations for computing the first value, the second value, and the third value is performed using a modular arithmetic with an order of a base point of an elliptic curve as a modulus.

7. The digital signature system according to claim 1, further comprising
a verification apparatus that is configured to verify the signature for the message using the verification key,
wherein the first signature generation apparatus or the second signature generation apparatus is configured to transmit the signature and the message to the verification apparatus.

8. A digital signature method comprising:
by a first apparatus:
acquiring and storing in a storage:
a first helper key generated using first secret information corresponding to a verification key and first biometric information;
helper data generated using second secret information for distributed signature generation and the first biometric information; and
third secret information for distributed signature generation;
generating a second distributed key; and
generating a second distributed signature for the message to be signed by using the second distributed key and the third secret information, and sending/receiving information with a second apparatus,
the method comprising:
by the second apparatus:
acquiring second biometric information;
acquiring the helper data;
restoring the second secret information using the second biometric information and the helper data;
generating a first distributed key; and
generating a first distributed signature for the message, by using the first distributed key and the second secret information and sending/receiving information with the first apparatus,
the method further comprising
by one of the first apparatus or the second apparatus,
generating a signature for the message using:
one of the first distributed signature or the second distributed signature generated by the one of the first apparatus or the second apparatus; and
other of the first distributed signature or the second distributed signature generated by other of the first apparatus or the second apparatus.

9. The digital signature method according to claim 8, comprising:
by the second apparatus:
generating a second helper key using the first distributed key and the second biometric information; and
transmitting the second helper key to the first apparatus,
the method comprising:
by the first apparatus:
receiving the second helper key; and
generating the second distributed key using the first helper key and the second helper key.

10. The digital signature method according to claim 8, comprising:
by the first apparatus:
generating a second helper key using the helper data and the second distributed key; and
transmitting the second helper key to the second apparatus,
the method comprising:
by the second apparatus:
receiving the second helper key; and
generating the first distributed key using the second helper key and the second biometric information.

11. The digital signature method according to claim 8, comprising:
by a third apparatus:
acquiring the first biometric information;
generating the first secret information corresponding to a secret key;
generating a verification key from the first secret information and the base point of the elliptic curve;
generating the first helper key using the first secret information and the first biometric information;
generating the second secret information;
generating the helper data using the second secret information and the first biometric information; and
transmitting the first helper key and the helper data to the first apparatus,
the method comprising
by the fourth apparatus:
generating the third secret information, transmits the third secret information to the first apparatus;
the method further comprising:
by the first apparatus:
receiving and storing in the first storage part and the second storage part, the first helper key and helper data transmitted from the third apparatus, respectively, and
receiving and storing in the third storage part, the third secret information transmitted from the fourth apparatus.

12. The digital signature method according to claim 8, comprising:
by the second apparatus:
computing a first hash value related to the second secret information and the message;
computing a first point of the elliptic curve from the first hash value and a base point of the elliptic curve;
transmitting the first point of the elliptic curve to the first apparatus;
computing a second hash value of a third point obtained by adding on the elliptic curve the first point of the elliptic curve and a second point of the elliptic curve received from the first apparatus, the verification key, and the message;
computing a first value as the first distributed signature, which is a sum of the first hash value and a value obtained by multiplying the second hash value by the first distributed key,
the method comprising:
by the first apparatus:
computing a third hash value regarding the third secret information and the message;
computing a second point on the elliptic curve from the base point of the elliptic curve using the third hash value;
transmitting the second point on the elliptic curve to the second apparatus;
computing a fourth hash value of a third point obtained by adding the first point on the elliptic curve received from the second apparatus and the second point on the elliptic curve on the elliptic curve, the verification key, and the message;
computing the second value, which is a sum of the third hash value and the value obtained by multiplying the fourth hash value by the second distribution key, as the second distributed signature,
the method comprising
by the first apparatus or the second apparatus:
computing a third value by adding the second value to the first value; and
setting a set of third point on the elliptic curve and the third value as a signature for the message.

13. The digital signature method according to claim 12, wherein each operation for computing the first value, the second value, and the third value is performed using modular arithmetic with an order of a base point of the elliptic curve as a modulus.

14. The digital signature method according to claim 8, comprising
by the first apparatus or the second apparatus,
transmitting the signature and the message to a verification apparatus that verifies the signature using the verification key.

15. A non-transitory storage medium storing a program causing a first processing apparatus to execute processing including:
acquiring and storing in a storage:
a first helper key generated using first secret information corresponding to a verification key and first biometric information;
helper data generated using second secret information for distributed signature generation and the first biometric information; and
third secret information for distributed signature generation;
generating a second distributed key; and
generating a second distributed signature for the message to be signed by using the second distributed key and the third secret information, and sending/receiving information with a second processing apparatus,
wherein the non-transitory storage medium stores a program causing a second processing apparatus to execute processing including:
acquiring second biometric information;
acquiring the helper data;
restoring the second secret information using the second biometric information and the helper data;
generating the first distributed key; and
generating the first distributed signature for the message by using the first distributed key and the second secret information and sending/receiving information with the first processing apparatus,
wherein the non-transitory storage medium stores the program causing one of the first processing apparatus or the second processing apparatus to execute processing including
generating a signature for the message using:
one of the first distributed signature or the second distributed signature generated by the one of the first processing apparatus or the second processing apparatus; and
other of the first distributed signature or the second distributed signature generated by other of the first processing apparatus and the second processing apparatus.

16. The non-transitory storage medium according to claim 15, storing the program causing the second processing apparatus to perform processing including:
generating a second helper key using the first distributed key and the second biometric information; and
transmitting the second helper key to the first processing apparatus,
wherein the non-transitory storage medium stores the program causing the first processing apparatus to perform processing including:
receiving the second helper key; and
generating the second distributed key using the first helper key and the second helper key.

17. The non-transitory storage medium according to claim 15, storing the program causing the first processing apparatus to perform processing including:
generating the second helper key using the helper data and the second distributed key; and
transmitting the second helper key to the second processing apparatus,
wherein the non-transitory storage medium stores the program causing the second processing apparatus to execute processing including
receiving the second helper key; and
generating the first distributed key using the second helper key and the second biometric information.
